(19) United States
(12) Patent Application Publication
(10) Pub. No.: US 2025/0306500 A1
(43) Pub. Date: Oct. 2, 2025

(54) DEVELOPING DEVICE

(71) Applicant: CANON KABUSHIKI KAISHA, Tokyo (JP)

(72) Inventors: Yukihide Ito, Kanagawa (JP); Tomofumi Kawamura, Shizuoka (JP); Masato Tanabe, Shizuoka (JP)

(21) Appl. No.: 19/082,285

(22) Filed: Mar. 18, 2025

(30) Foreign Application Priority Data
Mar. 29, 2024 (JP) 2024-057831

(51) Int. Cl. G03G 15/08

(52) U.S. Cl. CPC G03G 15/0808; G03G 15/0856; G03G 15/0891

(57) ABSTRACT

A developing device includes a developing roller, a supplying roller, and a developing container. The developing container includes a developing chamber, a developer accommodating chamber having an opening and an inner wall surface, a conveying member having a rotational axis, and a detecting portion. In a cross section perpendicular to the rotational axis, the detecting portion is provided in a region of the inner wall surface positioned between a first point and a second point with respect to the rotational direction of the conveying member, the first point being a downstream end of the opening with respect to the rotational direction, and the second point being a point where a virtual line passing through the rotational axis and an upstream end of the opening with respect to the rotational direction crosses the inner wall surface.

### FIELD OF THE INVENTION AND RELATED ART

The present invention relates to a developing device used in an image forming apparatus, such as a copying machine, a printer, a facsimile machine, or a multi-function machine having a plurality of functions of functions of these machines, using an electrophotographic type or an electrostatic recording type.

Conventionally, for example, the image forming apparatus such as the printer using the electrophotographic type includes the developing device for developing an electrostatic latent image, formed on an image bearing member, with a developer. The developing device is made detachably mountable to an apparatus main assembly of the image forming apparatus substantially singly or in made detachably mountable as a process cartridge to the apparatus main assembly of the image forming apparatus in combination with another element.

The developing device includes a developing chamber in which a developing member for supplying the developer to the image bearing member, or the like is provided, and includes a developer accommodating chamber (hereinafter, simply referred also to as an “accommodating chamber”) in which the developer supplied to the developing chamber is accommodated. The developing chamber and the accommodating chamber are partitioned by a partition wall, and the developer is supplied from the accommodating chamber toward the developing chamber through a supply opening which is an opening provided in the partition wall. In the accommodating chamber, a rotatable conveying member for conveying the developer is provided in many instances.

Further, there are cases where the developing device is provided with a remaining amount detecting portion for detecting a remaining amount of the developer in the developing device in which the developer is decreased with image formation. The image forming apparatus is capable of notifying a user of a detected remaining amount of the developer (or a consumption amount of the developer) in the developing device.

In a conventional constitution, a remaining amount detecting portion is provided in an accommodating chamber and a remaining amount of a developer in a developing device is developed. Thus, in the case where the remaining amount detecting portion is provided in the accommodating chamber, on the basis of an amount of the developer detected in the accommodating chamber, as the remaining amount of the developer in the developing device, a “total remaining amount of developer” which is the sum of an “amount of developer in accommodating chamber” and an “amount of developer in developing chamber” is calculated.

### SUMMARY OF THE INVENTION

According to an aspect of the present invention, there is provided a developing device used for image formation in an image forming apparatus, comprising: a developing roller configured to carry a developer; a supplying roller configured to supply the developer to the developing roller in contact with the developing roller; and a developing container by which the developing roller is rotatably supported, the developing container including a developing chamber provided with the supplying roller, a developer accommodating chamber partitioned from the developing chamber by a partition wall provided with an opening and configured to accommodate the developer, the developer accommodating chamber communicating with the developing chamber through the opening and being positioned above the developing chamber when the developing device takes an attitude in which the developing device is used for the image formation, a conveying member provided in the developer accommodating chamber and configured to convey the developer from the developer accommodating chamber toward the developing chamber through the opening, the conveying member being rotatable about a rotational axis thereof in a rotational direction opposite to a rotational direction of the supplying roller, and a detecting portion configured to output a signal depending on an amount of the developer accommodated in the developing chamber, the detecting portion being provided on an inner wall surface constituting the developer accommodating chamber, wherein in a cross section perpendicular to the rotational axis, the detecting portion is provided in a region of the inner wall surface positioned between a first point and a second point with respect to the rotational direction of the conveying member, the first point being a downstream end of the opening with respect to the rotational direction, and the second point being a point where a virtual line passing through the rotational axis and an upstream end of the opening with respect to the rotational direction crosses the inner wall surface.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of the image forming apparatus in a state in which a front door is open.

FIG. 3 is a schematic sectional view of the image forming apparatus in a state in which a cartridge tray is pulled out.

FIG. 4 is a schematic sectional view of the image forming apparatus in a state in which a process cartridge is detached.

FIG. 5 is a sectional view of the process cartridge.

FIG. 6 is an exploded perspective view of a drum unit.

FIG. 7 is an exploded perspective view of a developing unit.

FIG. 8 is an assembling perspective view of the process cartridge.

FIG. 9 is a perspective view of the process cartridge.

FIG. 10 is a schematic perspective view of the developing unit.

FIG. 11 is a schematic sectional view of the developing unit.

FIG. 12 is a schematic perspective view of a second developing (device) frame.

Parts (a) and (b) of FIG. 13 are schematic front view and a schematic side view, respectively of the second developing frame.

FIG. 14 is a schematic view of a developer remaining amount detecting constitution.

Parts (a) and (b) of FIG. 15 are schematic sectional views of the developing unit, for illustrating conveyance of the developer toward a remaining amount detecting portion.

Parts (a) and (b) of FIG. 16 are schematic sectional views in a neighborhood of a developing chamber, for illustrating a problem.

FIG. 17 is a schematic sectional view of the developing unit, for illustrating an effect of an embodiment.

### DESCRIPTION OF THE EMBODIMENTS

In the following, embodiments of a developing device according to the present invention will be described specifically with reference to the drawings. However, dimensions, materials, shapes, a relative arrangement, and the like of constituent parts described in the following embodiments should be appropriately changed depending on constitutions and various conditions of apparatuses (devices) to which the present invention is applied, and a scope of the present invention is not limited to the following embodiments.

### Embodiment 1

### General Structure and Operation of Image Forming Apparatus

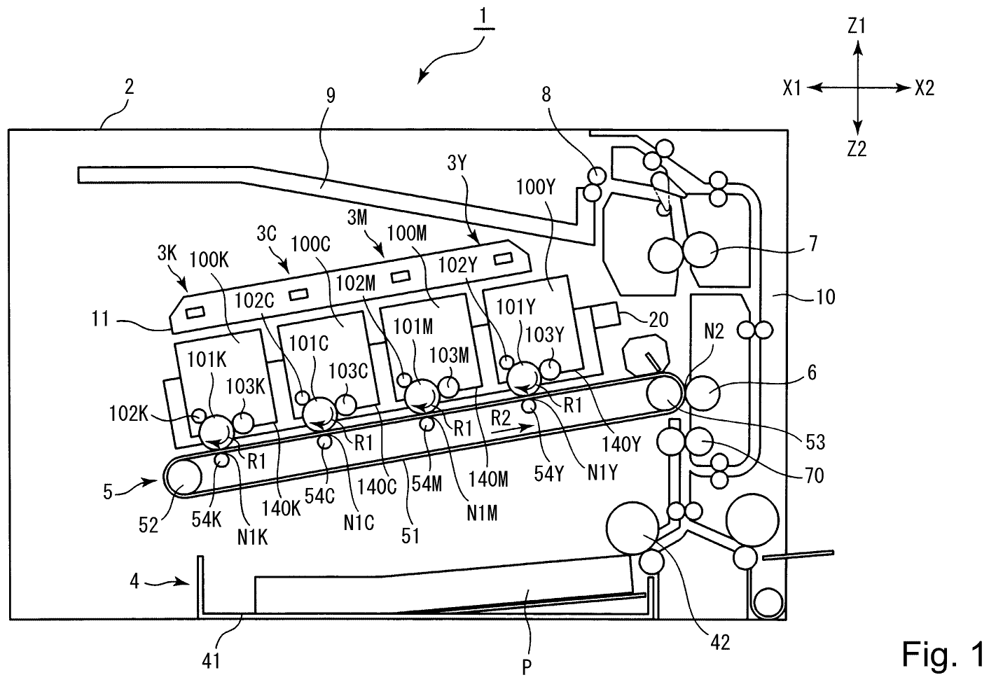

First, a general structure and an operation of an image forming apparatus in this embodiment will be described with reference to FIG. 1. FIG. 1 is a schematic sectional view of an image forming apparatus of this embodiment. The image forming apparatus 100 in this embodiment is a tandem laser beam printer which is capable of forming a full-color image on a sheet-like recording material P by utilizing an electrophotographic type, and which employs an intermediary transfer type. In addition, the image forming apparatus 1 in this embodiment employs a process cartridge type, in which process cartridges 100 (100Y, 100M, 100C, 100K) are detachably mounted to an apparatus main assembly 2 of the image forming apparatus 1 and carries out image formation. In this embodiment, the apparatus main assembly 2 of the image forming apparatus 1 is a portion excluding the process cartridges 100 (100Y, 100M, 100C, 100K) from the image forming apparatus 1. Incidentally, the recording material P is referred to as paper in some instances, but the recording material P includes a material other than paper, or a recording material formed of a material containing the material other than the paper (such as synthetic paper or a film which are formed with synthetic resin, metallized paper including a metal layer, or the like).

Here, as regards the image forming apparatus 1 and elements thereof, a right(-hand) side in FIG. 1 on which a front door 10 described later is referred to as a “front (front surface) side”, and a left(-hand) side in FIG. 1 which is an opposite side to the front side is referred to as a “rear (back) surface side”. Further, as regards the image forming apparatus 1 and the elements thereof, in the case where the image forming apparatus 1 is viewed from the front side, the right side is a “driving side” and the left side is a “non-driving side”. The driving side is a side where a drum coupling member for inputting a driving force to a photosensitive drum 101 described later and a development coupling member for inputting a driving force to a developing roller 103 described later are provided. Further, as regards the image forming apparatus 1 and the elements thereof, “upper (above)” and “lower (below)” refer to “upper (above)” and “lower (below)”, respectively, with respect to a gravitational direction (vertical direction), but are not intended to mean only “immediately upper (above)” and “immediately lower (below)”, respectively, and includes an “upper side” and a “lower side”, respectively, relative to a horizontal surface passing through an associated element or position. Further, a left-right direction in FIG. 1 connecting the front side and the rear side is an “X direction”, a direction connecting the non-driving side and the driving side and perpendicular to the drawing sheet of FIG. 1 is a “Y direction”, and a direction perpendicular to the X direction and the Y direction is a “Z direction”. The image forming apparatus 100 is disposed so that the Z direction is substantially parallel to the gravitational direction (so that each of the X direction and the Y direction is substantially parallel to a horizontal direction) and is used for image formation. Further, the Y direction is substantially parallel to rotational axis directions of the photosensitive drum 101 and the developing roller 103. In the X direction, a direction from the front side toward the rear side is an “X1 direction”, and a direction from the rear side toward the front side is an “X2 direction”. In the Z direction, a direction from the lower side toward the upper side is a “Z1 direction”, and a direction from the upper side toward the lower side is a “Z2 direction”. That is, the image forming apparatus 1 is disposed so that the Z2 direction becomes the gravitational direction. Further, in the Y direction, a direction from the non-driving side toward the driving side is a “Y1 direction”, and a direction from the driving side toward the non-driving side is a “Y2 direction”. FIG. 1 is a schematic sectional view of the image forming apparatus 1 showing a state in which a cross section (XZ plane) substantially perpendicular to the Y direction is viewed from the non-driving side, in which the front side of the drawing sheet is the non-driving side, and the rear side of the drawing sheet is the driving side.

The image forming apparatus 1 includes, as a plurality of image forming portions (stations), four image forming portions 3Y, 3M, 3C, and 3K for forming images of yellow (Y), magenta (M), cyan (C), and black (K), respectively. The four image forming portions 3Y, 3M, 3C, and 3K are provided in series along a movement direction of an image transfer surface of an intermediary transfer belt 51 described later. In this embodiment, this arrangement direction is a direction along a horizontal direction but is somewhat inclined relative to the horizontal direction in a state in which the image forming apparatus 1 is installed on a horizontal surface. Incidentally, elements having identical or corresponding functions or constitutions provided for the respective colors are collectively described by omitting suffixes Y, M, C, and K of reference numerals or symbols each showing the element for an associated one of the colors in some instances. In this embodiment, the image forming portion 3 is constituted by including the photosensitive drum 101 (101Y, 101M, 101C, 101K), a charging roller 102 (102Y, 102M, 102C, 102K), a laser scanner unit (exposure device) 11, a developing unit (developing device) 140, and the like. In this embodiment, the laser scanner unit 11 is constituted as a single unit for exposing the four photosensitive drums 101Y, 101M, 101C, and 101K to light, but may be provided for the respective photosensitive drums 101 independently of each other.

The photosensitive drum 1 which is a rotatable drum-shaped (cylindrical) photosensitive member (electrophotographic member) as an image bearing member is rotationally driven in an arrow R1 direction in FIG. 1 (clockwise direction) at a predetermined peripheral speed (process speed). A surface (outer peripheral surface) of the rotating photosensitive drum 101 is electrically charged uniformly to a predetermined potential of a predetermined polarity (negative polarity in this embodiment) by the charging roller 102 which is a roller-shaped charging member as a charging means. The charging roller 102 is provided in contact with the surface of the photosensitive drum 101 and is rotated with rotation of the photosensitive drum 101. During the charging, to the charging roller 102, by a charging power source (not shown) as a charging voltage applying portion, a predetermined charging bias (charging voltage) which is a DC voltage of the same polarity as a charge polarity (negative polarity in this embodiment) of the photosensitive drum 101 is applied. The charged surface of the photosensitive drum 101 is subjected to scanning exposure by the laser scanner unit 11 to laser light 12 depending on an image signal of a color component corresponding to an associated one of the image forming portions 3. By this, on the photosensitive drum 101, an electrostatic latent image (electrostatic image) depending on the image signal of the color component corresponding to the associated image forming portion 3 is formed.

The electrostatic latent image formed on the photosensitive drum 101 is developed (visualized) by being supplied with a developer (hereinafter, also referred to as “toner”) by the developing unit 140 as a developing means, so that a toner image (toner picture, developer image) is formed on the photosensitive drum 101. In this embodiment, the developing unit 140 uses a non-magnetic one-component developer (toner) as the developer. The developing unit 140 includes the developing roller 103 as a developer carrying member (developing member). The developing roller 103 conveys the toner toward a developing portion which is an opposing portion (contact portion) with the photosensitive drum 101 while carrying the toner. During the development, the developing roller 103 contacts the photosensitive drum 101. Further, during the development, the developing roller 103 is rotationally driven at a predetermined peripheral speed in a direction in which the surface movement direction of the photosensitive drum 101 and a surface (outer peripheral surface) movement direction of the developing roller 103 become the same (forward) direction in the developing portion. Further, during the development, to the developing roller 103, a predetermined developing bias (developing voltage) which is a DC voltage of the same polarity as the charge polarity (negative polarity in this embodiment) of the photosensitive drum 101 is applied by a developing power source (not shown) as a developing voltage applying portion. By this, the toner is supplied from the surface of the developing roller 103 to the surface of the photosensitive drum 101 depending on the electrostatic latent image on the photosensitive drum 101, so that the electrostatic latent image on the photosensitive drum 101 is developed. In this embodiment, on an exposed portion (image portion) of the surface of the photosensitive drum 101 lowered in absolute value of the potential by being exposed to light after being charged uniformly, the toner charged to the same polarity as the charge polarity (negative polarity in this embodiment) of the photosensitive drum 101 is deposited (reverse development type). In this embodiment, a normal charge polarity of the toner which is a principal charge polarity of the toner during the development is the negative polarity.

Below the four photosensitive drums 101Y, 101M, 101C, and 101K, an intermediary transfer unit 5 is provided so as to oppose these four photosensitive drums 101Y, 101M, 101C, and 101K. The intermediary transfer unit 5 includes the intermediary transfer belt 51 constituted by an endless belt as an intermediary transfer member, a driving roller 52 and a tension roller 53 which are as a plurality of stretching rollers (supporting rollers), and four primary transfer rollers 54Y, 54M, 54C, and 54K. A flexible intermediary transfer belt 51 is extended around the driving roller 52 and the tension roller 53 and is stretched under a predetermined tension. Further, on an inner peripheral surface side of the intermediary transfer belt 51, correspondingly to the photosensitive drums 101Y, 101M, 101C, and 101K, the primary transfer rollers 54Y, 54M, 54C, and 54K, respectively, which are roller-shaped primary transfer member as primary transfer means are provided. The primary transfer roller 54 presses the intermediary transfer belt 51 toward the associated photosensitive drum 101 and forms a primary transfer portion (primary transfer nip) N1 (N1Y, N1M, N1C, N1K) which is a contact portion between the photosensitive drum 101 and the intermediary transfer belt 51. In this embodiment, the photosensitive drum 101 contacts an upper surface of the intermediary transfer belt 51 at a lower surface thereof. The contact portion is the primary transfer portion N1. To the intermediary transfer belt 51, a driving force is transmitted by rotationally driving the driving roller 53, so that the intermediary transfer belt 51 is rotated (circulated and moved) in an arrow 2 direction in FIG. 1 (counterclockwise direction). The tension roller 53 and the primary transfer roller 54 are rotated with rotation of the intermediary transfer belt 51. The toner image formed on the photosensitive drum 101 is (transferred primarily transferred) onto the rotating intermediary transfer belt 51 in the primary transfer portion N1. During the primary transfer, to the primary transfer roller 54, a primary transfer bias (primary transfer voltage) which is a DC voltage of an opposite polarity (positive polarity in this embodiment) to the normal charge polarity is applied. For example, during full-color image formation, the toner images of the respective colors of yellow, magenta, cyan, and black formed on the photosensitive drums 101 are transferred superposedly onto the intermediary transfer belt 51 in an image forming region.

Incidentally, when an image forming operation is started, rotational drive of the photosensitive drums 101, rotational drive of the intermediary transfer belt 51, and drive of the laser scanner unit 11 are started. Then, in synchronism with the drive of the laser scanner unit 11, the charging of the surface of the photosensitive drum 101 by the charging roller 102 is started.

On an outer peripheral surface side, in a position opposing the driving roller 53, a secondary transfer roller 6 which is a roller-shaped secondary transfer member as a secondary transfer means is provided. The secondary transfer roller 6 is pressed toward the driving roller 53 and is contacted to the driving roller 53 through the intermediary transfer belt 51, and thus forms a secondary transfer portion (secondary transfer nip) N2 which is a contact portion between the intermediary transfer belt 51 and the secondary transfer roller 6. The secondary transfer roller 6 is rotated with the rotation of the intermediary transfer belt 51. The toner image formed on the intermediary transfer belt 51 is transferred (secondarily transferred) onto the recording material P nipped and conveyed by the intermediary transfer belt 51 and the secondary transfer roller 6 in the secondary transfer portion N2. During the secondary transfer, to the secondary transfer roller 6, a predetermined secondary transfer bias (secondary transfer voltage) which is a DC voltage of the opposite polarity (positive polarity in this embodiment) to the normal charge polarity of the toner is applied. The recording material (recording medium, transfer material, sheet) P is supplied from a feeding unit 4 provided below the intermediary transfer unit 5 toward the secondary transfer portion N2. The feeding unit 4 is constituted by a sheet (paper) feeding tray 41 in which recording materials P such as paper are stacked and accommodated, and a sheet feeding roller 42 as a feeding member, or the like. At a predetermined control timing, the recording materials P are separated and fed one by one from the sheet feeding tray 41 by the sheet feeding roller 42, and the fed recording material P is conveyed toward a registration roller pair 70 as a recording material conveying member. This recording material P is conveyed toward the secondary transfer portion N2 at a predetermined control timing by the registration roller pair 70.

The recording material P onto which the toner image is transferred is conveyed toward a fixing device 7 as a fixing means. The fixing device 7 fixes (melts, sticks) the toner image on the recording material P by heating and pressing the recording material P on which an unfixed toner image is carried. The recording material P on which the toner image is fixed is discharged (outputted) by a discharging roller pair 8 or the like as a discharging member onto a sheet discharge tray 9 as a discharging portion provided outside (upper portion) of the apparatus main assembly 2.

In this embodiment, in each of the image forming portions 3, the photosensitive drum 101, and as process means actable thereon, the charging roller 102 and the developing unit 140 integrally constitute a process cartridge 100 detachably mounted to the apparatus main assembly 2. In this embodiment, the four process cartridges 100Y, 100M, 100C and 100K are detachably mountable to the apparatus main assembly 2. The four process cartridges 100Y, 100M, 100C, and 100K have the same electrophotographic process and are different from each other in color of the toner used. Further, toner filling amounts may be different from each other between at least two process cartridges 100. To the process cartridge 100, a rotational driving force is transmitted from a driving force outputting portion (details thereof will be described later) of the apparatus main assembly 2, so that electric biases (charging bias, developing bias, remaining amount detecting bias, and the like) are supplied from controls (not shown) of the apparatus main assembly 2. Incidentally, the number of the process cartridges detachably mountable to the apparatus main assembly of the image forming apparatus is not limited to four, but may be appropriately set as needed.

### Mounting and Demounting Constitution of Process Cartridge

Next, mounting and demounting of the process cartridge 100 relative to the apparatus main assembly 2 in this embodiment will be described.

As shown in FIG. 1, the image forming apparatus 1 is provided with a movable cartridge tray 20 for supporting the process cartridge 100. In addition, the image forming apparatus 1 is provided with the front door 10 openable and closable for permitting mounting and demounting of the process cartridge 100 relative to the apparatus main assembly 2. In this embodiment, the front door 10 is rotatable about a rotational axis provided at a lower end portion thereof and substantially parallel to the Y direction, so that an upper end portion thereof in a closed state is opened by being moved downward, and the upper end portion is closed by being moved upward.

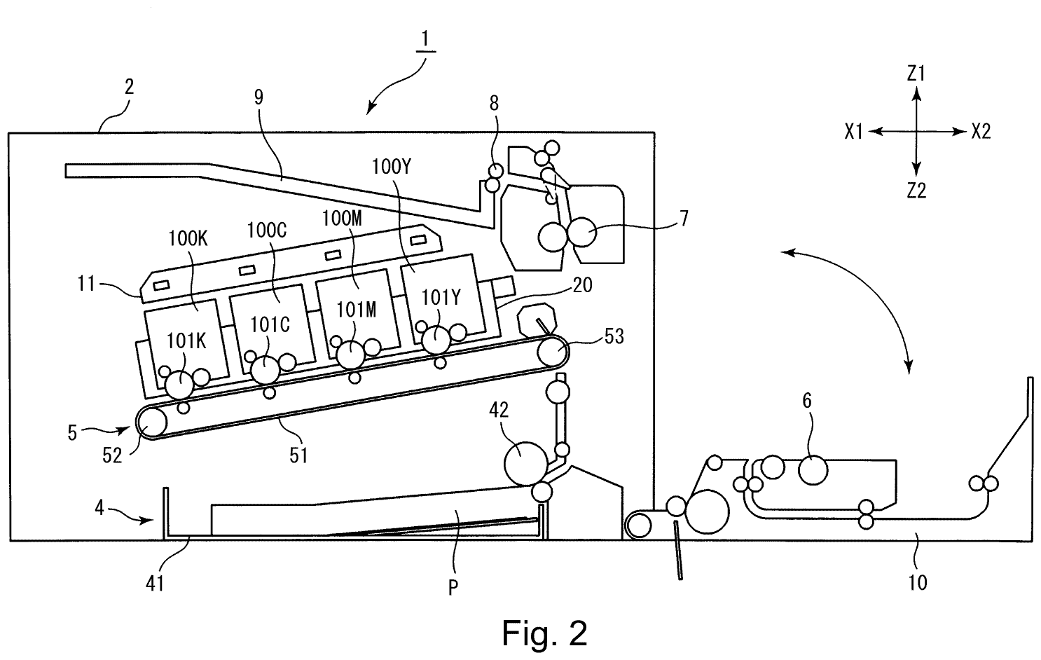

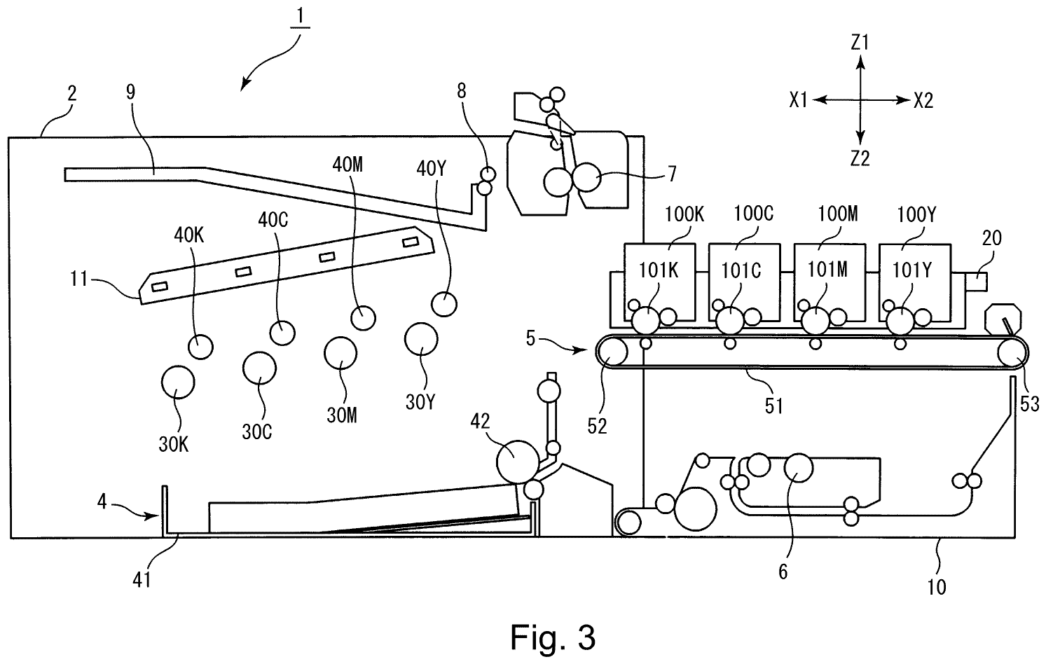

FIG. 2 is a schematic sectional view of the image forming apparatus 1 in a state in which the cartridge tray 20 is positioned inside the apparatus main assembly 2. FIG. 3 is a schematic sectional view of the image forming apparatus 1 in a state in which the cartridge tray 20 is positioned outside the apparatus main assembly 2 and in which the process cartridges 100 are accommodated in the cartridge tray 20.

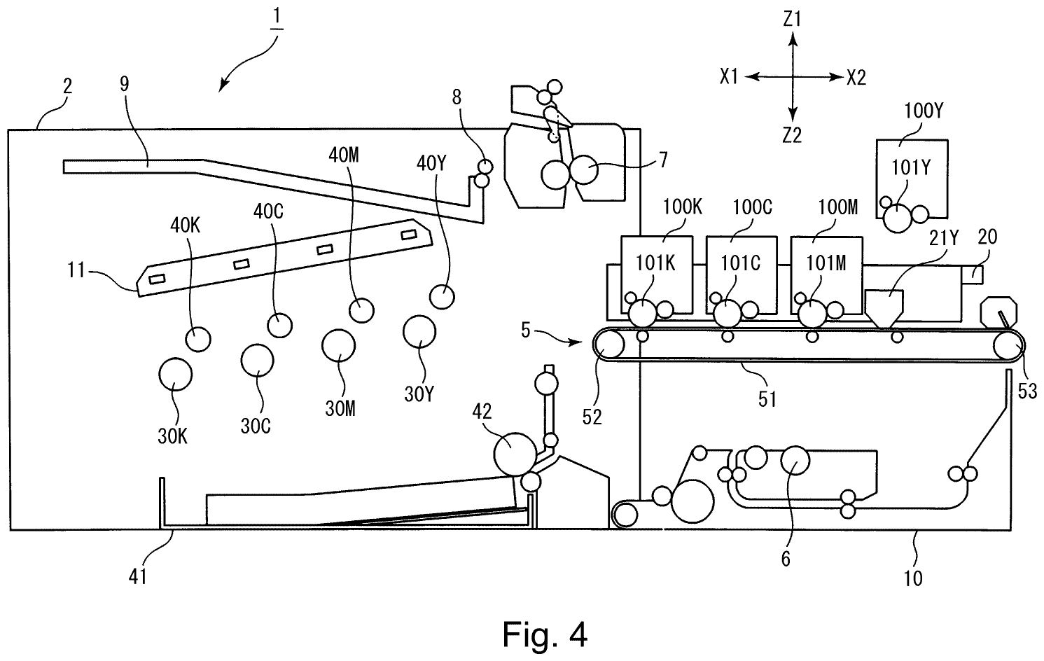

Further, FIG. 4 is a schematic sectional view of the image forming apparatus 1 in a state in which the front door 10 is open and the cartridge tray 20 is positioned outside the apparatus main assembly 2 and in which the process cartridge 100Y for yellow is demounted from the cartridge tray 20. FIGS. 2 to 4 each shows a state in which the cross section (XZ plane) substantially perpendicular to the Y direction is viewed from the non-driving side.

As shown in FIGS. 2 and 3, the cartridge tray 20 is movable in an arrow X1 direction (pushing-in direction) and in an arrow X2 direction (pulling-out direction). That is, the cartridge tray 20 is constituted, so that the cartridge tray is capable of being pulled out and pushed in relative to the apparatus main assembly 2 by being moved in a substantially horizontal direction in a state in which the apparatus main assembly 2 is disposed on the horizontal surface. Here, a state (state of FIG. 3) in which the front door 10 is open and the cartridge tray 20 is positioned outside the apparatus main assembly 2 is referred to as an “outside state”. Further, a state (state of FIG. 3) in which the front door 10 is open and the cartridge tray 20 is positioned inside the apparatus main assembly 2 is referred to as an “inside state”. In the outside state and in the inside state, each of the photosensitive drums 101 and the intermediary transfer belt 51 are separated from each other. Incidentally, in this embodiment, the intermediary transfer unit 5 is movable together with the cartridge tray 20 in the arrow X1 direction (pushing-in direction) and in the arrow X2 direction (pulling-out direction). Further, in this embodiment, the image forming apparatus 1 is constituted so that the fixing device 7 is movable in an arrow Z1 direction (upward) when a pulling-out operation and a pushing-in operation of the cartridge tray 20 (and the intermediary transfer unit 5) relative to the apparatus main assembly 2 are performed.

Further, as shown in FIG. 4, the cartridge tray 20 includes a mounting portion 21 to which each process cartridge 100 is detachably mountable in the outside state. In FIG. 4, only the mounting portion 21 for the process cartridge 100Y for yellow is illustrated, but the cartridge tray 20 similarly includes mounting portions 21 for other process cartridges 100M, 100C, and 100K.

Further, the process cartridge 100 is moved to an inside of the apparatus main assembly 2 by moving the cartridge tray 20 to the inside of the apparatus main assembly 2 in a state in which the process cartridge is mounted to the mounting portion 21. In this embodiment, the intermediary transfer unit 5 is moved (raised) in the arrow Z1 direction (upward) by a link mechanism (not shown) by closing the front door 10. By this, the intermediary transfer unit 5 is moved to a position (position where the photosensitive drum 101 and the intermediary transfer belt 51 are in contact with each other) during the image formation. Further, in this embodiment, the intermediary transfer unit 5 is moved (lowered) in an arrow Z2 direction (downward) by the link mechanism by opening the front door 10. By this, the intermediary transfer unit 5 is moved to a position where the photosensitive drum 101 and the intermediary transfer belt 51 are separated from each other.

Thus, by the cartridge tray 20, the plurality of process cartridges 100 can be moved together to a position inside the apparatus main assembly 2 where the image is capable of being formed and a position outside the apparatus main assembly 2 where each process cartridge 100 is capable of being demounted (removed).

### General Structure of Process Cartridge

Next, a general structure of the process cartridge 100 in this embodiment

will be described.

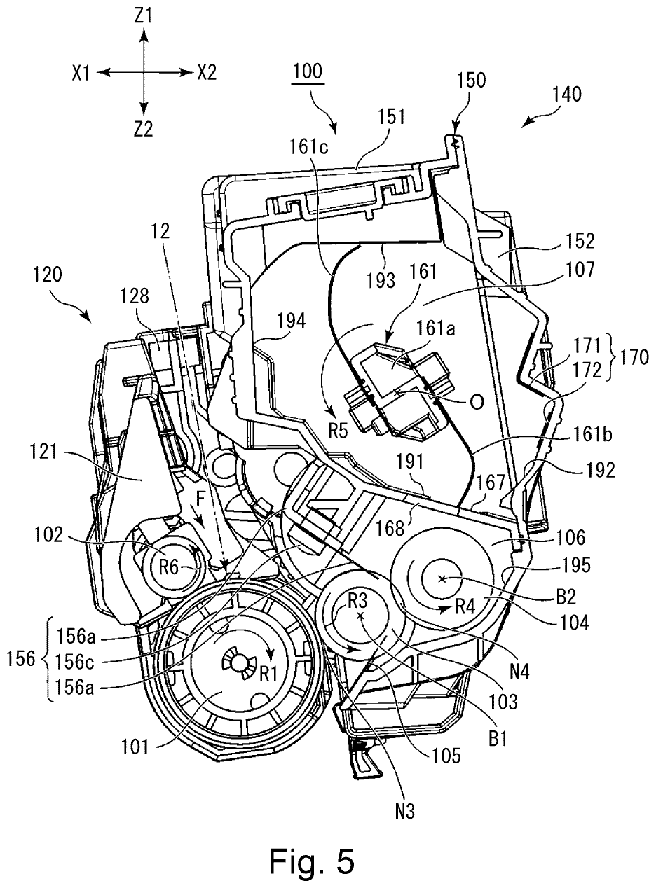

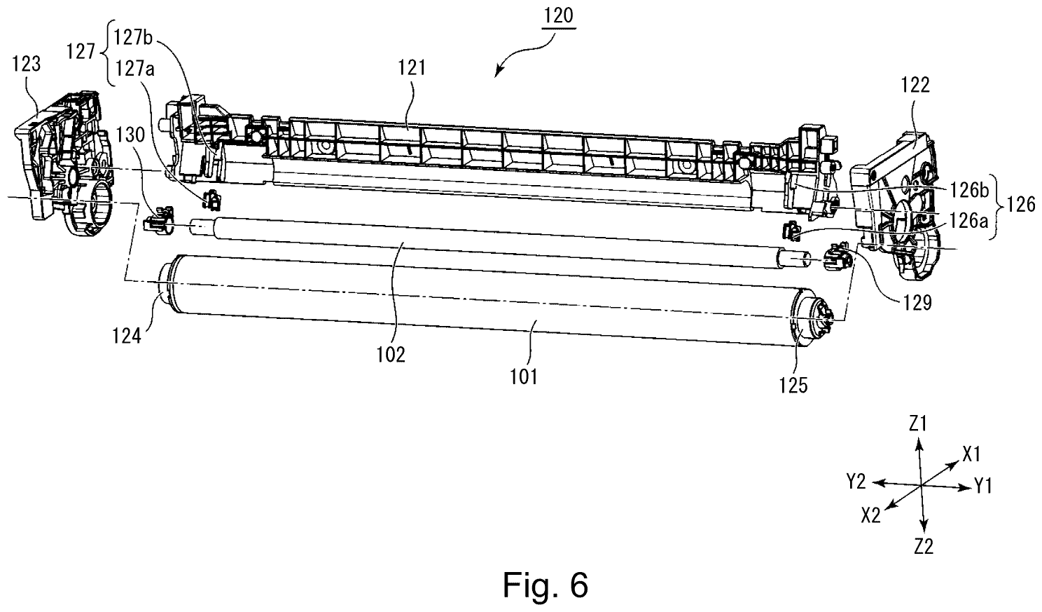

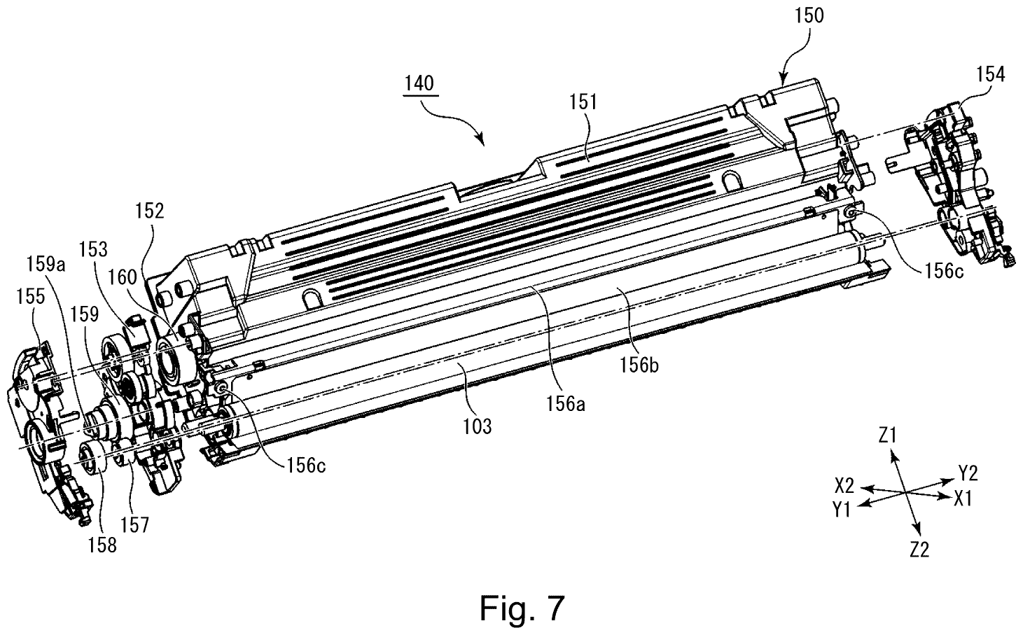

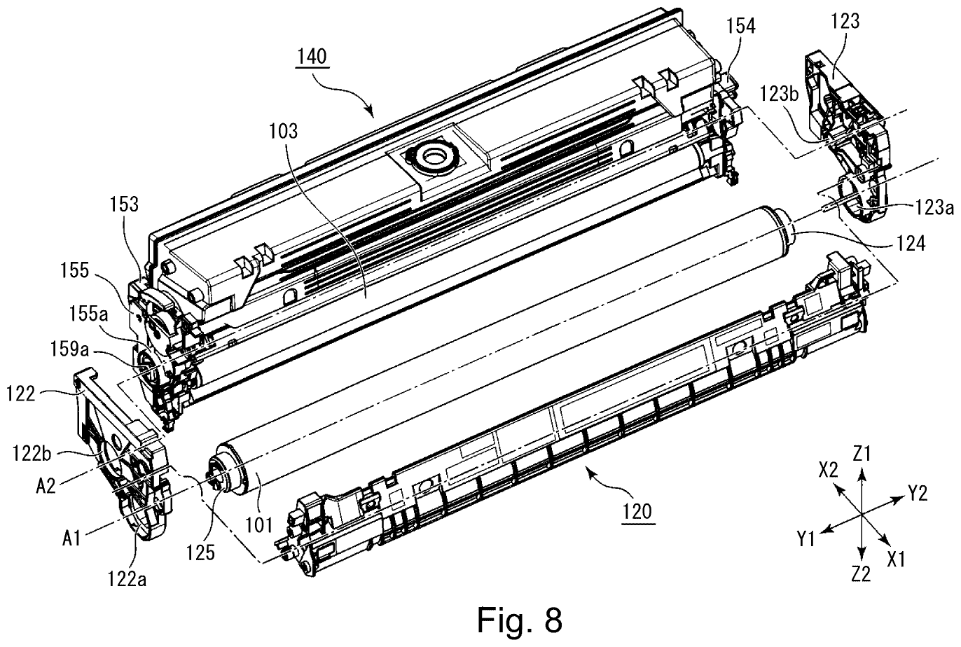

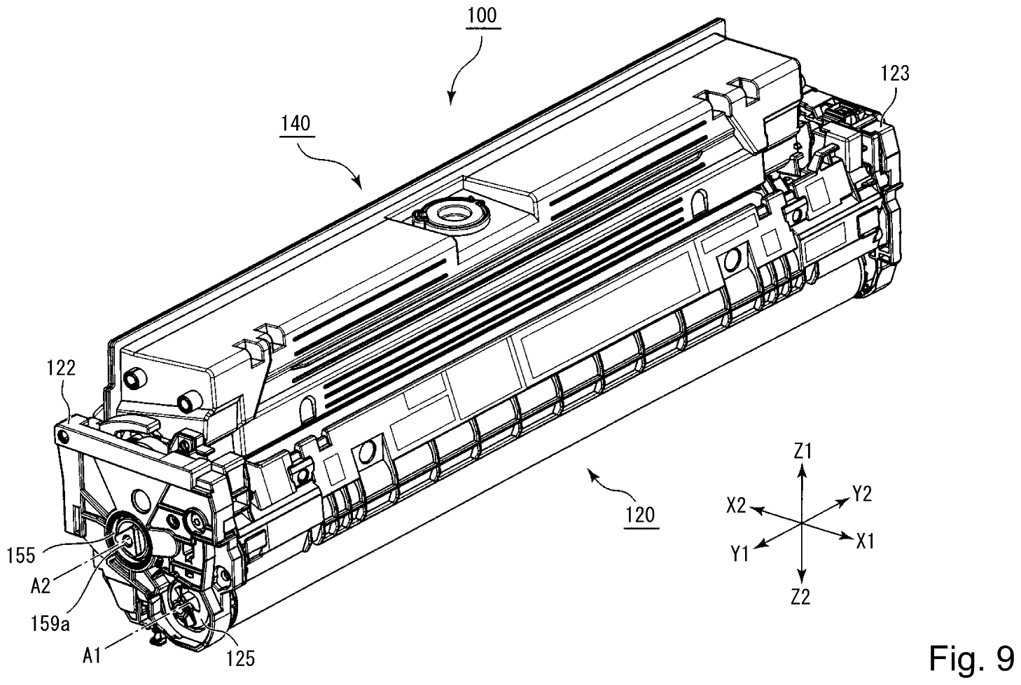

FIG. 5 is a sectional view of the process cartridge 100, showing a state in which a cross section (XZ plane) of the process cartridge 100 substantially perpendicular to the Y direction is viewed from the non-driving side. FIG. 6 is an exploded perspective view of a drum unit 120 described later constituting the process cartridge 100 (FIG. 6 shows a state as viewed from somewhat above along the X1 direction so that the left side is the non-driving side and the right side is the driving side in FIG. 6). FIG. 7 is an exploded perspective view of the developing unit 140 constituting the process cartridge 100 (FIG. 7 shows a state as viewed from somewhat below along the X2 direction so that the left side is the driving side and the right side is the non-driving side in FIG. 7). FIG. 8 is an assembling the process cartridge 100 (FIG. 8 shows a state as viewed from somewhat above along the X2 direction so that the left side is the driving side and the right side is the non-driving side in FIG. 8). FIG. 9 is a perspective view of the process cartridge 100 (FIG. 9 shows a state as viewed from somewhat above along the X2 direction so that the left side is the driving side and the right side is the non-driving side in FIG. 9).

In this embodiment, the process cartridge 100 includes the drum unit 120 provided with the photosensitive drum 101, and as a process means actable thereon, the charging roller 102 which is a charging means. Here, the drum unit 120 may include, as the process means, not only the charging means but also a cleaning means for cleaning a surface of the photosensitive drum 101.

Further, the process cartridge 100 includes, as the process means actable on the photosensitive drum 101, the developing unit (developing device) 140 which is a developing means for developing the electrostatic latent image on the photosensitive drum 101. The drum unit 120 and the developing unit 140 are connected to each other. The process cartridges 100Y, 100M, 100C, and 100K for the colors of yellow, magenta, cyan, and black accommodate toner of the colors of yellow, magenta, cyan, and black, respectively. In the apparatus main assembly 2, above the four process cartridges 100Y, 100M, 100C, and 100K, the laser scanner unit 11 is disposed. This laser scanner unit 11 outputs the laser light 12. Then, the laser light 12 passes through an exposure window 128 of the process cartridge 100, so that the surface of the photosensitive drum 101 is subjected to scanning exposure to the laser light 12. A specific structure of the process cartridge 100 will be described later.

Incidentally, as regards the process cartridge 100, the drum unit 120, the developing unit 140, or elements of these members, a direction substantially parallel to a rotational axis A1 direction (see FIG. 8) of the photosensitive drum 101 is also referred to as a “longitudinal direction”. The process cartridge 100 is disposed so that a rotational axis A1 of the photosensitive drum 101 is disposed so as to become substantially parallel to the Y direction and is used for image formation. Accordingly, the above-described longitudinal direction is a direction substantially parallel to the Y direction.

### Structure of Drum Unit

As shown in FIG. 6 and FIG. 8, the drum unit 120 is constituted by including the photosensitive drum 101, the charging roller 102, a drum frame 121, and the like. The charging roller 102 is rotatably supported by a driving-side charge bearing 126a and a non-driving-side charge bearing 127a in a opposite end portions thereof with respect to the longitudinal direction. The charging roller 102 is pressed toward the photosensitive drum 101 (arrow F direction in FIG. 5) by urging the driving-side charge bearing 126a and the non-driving-side charge bearing 127a by pressing springs 126b and 127b, respectively, which are urging members as urging means. The driving-side charge bearing 126a and the pressing spring 126b constitute a driving-side charging roller bearing unit 126. Further, the non-driving-side charge bearing 127a and the pressing spring 127b constitute a non-driving-side charging roller bearing unit 127. Further, to opposite end portions of the charging roller 102 with respect to the longitudinal direction, for example, until use of a new process cartridge 100 is started, separating members 129 and 130 for separating the charging roller 102 from the photosensitive drum 101 are mounted, respectively.

The photosensitive drum 101 is rotatably supported by a driving-side cartridge cover member 122 and a non-driving-side cartridge cover member 123 in opposite end portions thereof with respect to the longitudinal direction. Each of the driving-side cartridge cover member 122 and the non-driving-side cartridge cover member 123 is fixed to the drum frame 121 by an arbitrary fixing means such as bonding, welding, or fastening.

As shown in FIG. 8, in a driving-side end portion of the photosensitive drum 101 with respect to the longitudinal direction, a drum coupling member 125 as a drive input portion for transmitting a driving force to the photosensitive drum 101 is provided. The drum coupling member 125 engages with a main assembly-side drum driving coupling 30 (FIGS. 3 and 4) as a drive output portion provided in the apparatus main assembly 2. Further, a driving force from a driving motor (not shown) provided in the apparatus main assembly 2 is transmitted to the photosensitive drum 101 through the main assembly-side drum driving coupling 30 and the drum coupling member 125, so that the photosensitive drum 101 is rotated. Further, a drum flange 124 is provided in a non-driving-side end portion of the photosensitive drum 101 with respect to the longitudinal direction. The photosensitive drum 101 is rotationally driven in an arrow R1 direction (clockwise direction) in FIG. 5. The charging roller 102 is rotated in an arrow R6 direction (counterclockwise direction) in FIG. 5 with the rotation of the photosensitive drum 101. Each of the driving-side charge bearing 126a and the non-driving-side charge bearing 127a is supported by the drum frame 121 so as to be capable of being rotated with the rotation of the photosensitive drum 101 in contact with the surface of the photosensitive drum 101. Each of the driving-side charge bearing 126a and the non-driving-side charge bearing 127a is supported by the drum frame 121 so as to be movable in directions toward and away from the photosensitive drum 101 by contact of the charging roller 102 with the photosensitive drum 101. Further, the photosensitive drum 101 is supported by the drum frame 121 by that the drum coupling member 125 and the drum flange 124 are rotatably supported by the driving-side cartridge cover member 122 and the non-driving-side cartridge cover member 123, respectively.

### Structure of Developing Unit

As shown in FIGS. 5 and 7, the developing unit 140 is constituted by including the developing roller 103, a supplying roller 104, a sealing sheet 105, a developing blade 156, a conveying member 161, a remaining amount detecting member (electroconductive sheet) 170, a developing (device) frame 150, and the like. The developing frame 150 constitutes a developer container for accommodating the developer (toner). The developing frame 150 is constituted by a first developing frame 151 and a second developing frame 152 which are frames (resin frames) formed of a resin. In this embodiment, the first developing frame 151 and the second developing frame 152 are bonded together by ultrasonic welding. However, the first developing frame 151 and the second developing frame 152 can be fixed to each other by an arbitrary fixing means such as bonding, welding, or fastening. The developing frame 150 forms a developing chamber 106 provided with the developing roller 103 and the like, and a developer accommodating chamber (“accommodating chamber”) 107 for accommodating the toner supplied to the developing roller 103. The developing chamber 106 and the accommodating chamber 107 are partitioned by a partition wall 167 constituted by a part of the developing frame 150 (first developing frame 151).

First, in the developing chamber 106, the developing roller 103 as a developer carrying member (developing member) for conveying the toner toward a developing portion (developing nip) N3 which is an opposing portion (contact portion) with the photosensitive drum 101 while carrying the toner. Further, in the developing chamber 106, the supplying roller 104 as a supplying member for supplying the toner to the developing roller 103 is provided. In addition, in the developing chamber 106, the developing blade 156 as a regulating member is provided. In addition, in the developing chamber 106, the sealing sheet 105 as the sealing member is provided.

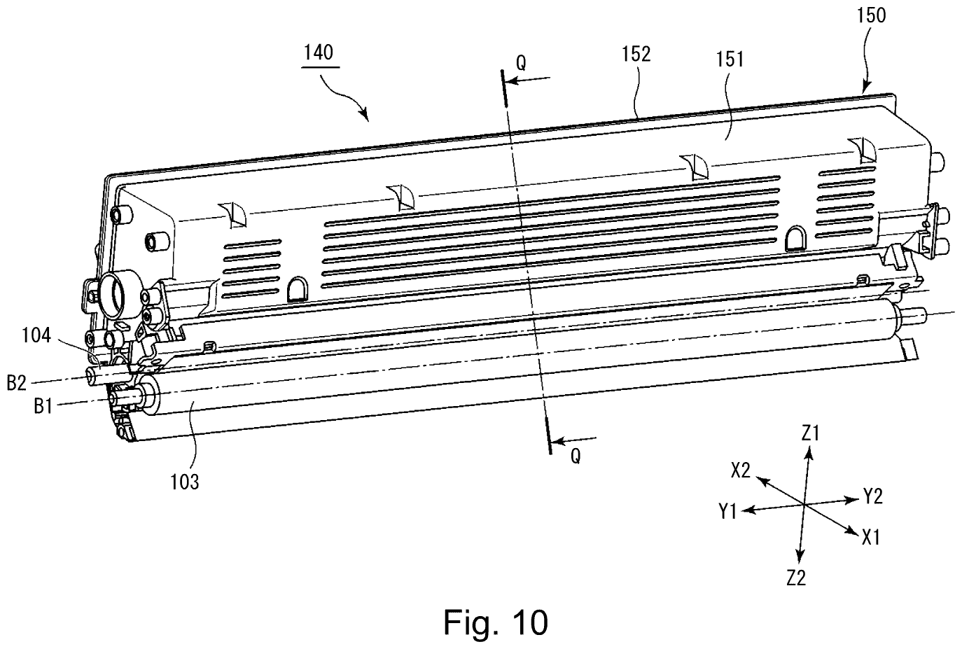

The developing roller 103 is an electroconductive rubber roller prepared by forming an electroconductive rubber layer as an elastic layer on an outer periphery of an electroconductive core metal. In this embodiment, the developing roller 103 is rotationally driven in an arrow R3 direction in FIG. 5 about a rotational axis B1 (see FIG. 10) substantially parallel to the longitudinal direction of the developing unit 140. That is, the developing roller 103 is rotationally driven in a direction in which a surface movement direction of the photosensitive drum 101 and a surface movement direction of the developing roller 103 become the same (forward) direction in the developing portion N3.

The supplying roller 104 is an elastic sponge roller prepared by forming a foamed elastic (member) layer as an elastic layer on an outer periphery of an electroconductive core metal. That is, the supplying roller 104 includes a foamed member (porous member) on a surface (outer peripheral surface) thereof. The supplying roller 104 contacts the developing roller 103 with a predetermined penetration amount, so that the foamed elastic layer constituting a surface layer of the supplying roller 104 is compressed and recessed by the elastic layer of the developing roller 103 higher in rigidity than the foamed elastic layer. A contact portion between the developing roller 103 and the supplying roller 104, i.e., a region (region-to-be-compressed) in which the supplying roller 104 is compressed by the developing roller 103 is also referred to as a “supplying portion (supplying nip) N4”. In this embodiment, the supplying roller 104 is rotationally driven in an arrow R4 direction (counterclockwise direction) in FIG. 5 about a rotational axis B2 (see FIG. 10) substantially parallel to the longitudinal direction of the developing unit 140. That is, the supplying roller 104 is rotationally driven in a direction in which the surface movement direction of the developing roller 103 and a surface movement direction of the supplying roller 104 becomes opposite directions to each other in the supplying portion N4. In the supplying portion N4, the toner is supplied to the developing roller 103 by the supplying roller 104.

The developing blade 156 is provided in contact with the surface of the developing roller 103 on a side downstream of the supplying portion N4 and upstream of the developing portion N3 with respect to the rotational direction of the developing roller 103.

In this embodiment, the developing blade 156 includes a regulating portion 156b constituted by an electrically deformable sheet-like member formed of metal in a thickness of about 0.1 mm, and a supporting member 156a constituted by a plate-like member (metal plate) formed of metal in an approximate L-shape in cross section (XZ plane) substantially perpendicular to the longitudinal direction. The regulating portion 156b is fixed to the supporting portion 156a in one end portion (fixing end portion) with respect to a widthwise direction substantially perpendicular to the longitudinal direction thereof. In this embodiment, the regulating portion 156b is fixed to the supporting member 156a by welding. However, the regulating portion 156b can be fixed to the supporting member 156a by an arbitrary fixing means such as bonding, welding, or fastening. The developing blade 156 is disposed so that the other end portion (free end portion) with respect to the widthwise direction of the regulating portion 156b is directed toward the upstream side with respect to a rotational direction of the developing roller 103. Further, the regulating portion 156b contacts the surface of the developing roller 103 at a side surface thereof in the neighborhood of a free end of the free end portion thereof with respect to the widthwise direction. The developing blade 156 regulates a layer thickness (coating amount) of the toner supplied to the developing roller 103 by the supplying roller 104. The developing blade 156 may have a function of imparting the electric charge to the toner. The developing blade 156 is held by the developing frame 150 as described later.

Further, the sealing sheet 105 is provided so as to contact the surface of the developing roller 103 on a side downstream of the developing portion N3 and upstream of the supplying portion N4 with respect to the developing roller 103. The sealing sheet 105 is constituted by a flexible sheet-like member. In this embodiment, the sealing sheet 105 is constituted by 0.06 mm-thick sheet-like member of polyphenylene sulfide (PPS). The sealing sheet 105 is fixed to the developing frame 150 as described later at one end portion (fixing end portion) thereof with respect to a widthwise direction substantially perpendicular to a longitudinal direction thereof. The sealing sheet 105 is disposed toward a downstream side with respect to the rotational direction of the developing roller 103 at the other end portion (free end portion) with respect to the widthwise direction thereof. Further, the sealing sheet 105 contacts the surface of the developing roller 103 at a side surface thereof in the neighborhood of a free end of the free end portion thereof with respect to the widthwise direction. The sealing sheet 105 prevents leaks of the toner from the developing chamber 106 to an outside.

On the other hand, in this embodiment, the accommodating chamber 107 is disposed above the developing chamber 106, i.e., above the supplying roller 104, and accommodates therein the toner to be supplied to the developing chamber 106. That is, in this embodiment, the developing chamber 106 is disposed below the accommodating chamber 107, and the supplying roller 104 is disposed below the accommodating chamber 107. Incidentally, this positional relationship between the developing chamber 106 and the accommodating chamber 107 is a positional relationship in the case where the developing unit 140 takes an attitude when the developing unit 140 is used for image formation in the image forming apparatus 1. The partition wall 167 for partitioning between the developing chamber 106 and the accommodating chamber 107 is provided with an opening 168 which is an opening for permitting passing of the toner from the accommodating chamber 107 toward the developing chamber 106 by establishing communication between the developing chamber 106 and the accommodating chamber 107. In the accommodating chamber 107, the conveying member (developer conveying member) for conveying the toner accommodated in the accommodating chamber 107 is disposed. The conveying member 161 also has a function as a stirring member (developer stirring member) for stirring the toner accommodated in the accommodating chamber 107. Further, in the accommodating chamber 107, the remaining amount detecting member (electroconductive sheet) 170 for detecting a remaining amount of the developer in the developing unit 140 is provided.

The accommodating chamber 107 roughly includes a bottom (surface) 191, a front-side inner wall surface 192, a top surface 193, and a rear-side inner wall surface 194. The bottom 191 is constituted by an inner wall surface of the partition wall 167. The front-side inner wall surface 192 is constituted by an inner wall surface extending along an up-down (vertical) direction so as to connect the bottom 191 and the top surface 193 on a front side of the accommodating chamber 107. The top surface 193 is constituted by an inner wall surface extending along a horizontal direction so as to connect the front-side inner wall surface 192 and the rear-side inner wall surface 194. The rear-side inner wall surface 194 is constituted by an inner wall surface extending along the up-down (vertical) direction so as to connect the top surface 193 and the bottom 191 on a rear side of the accommodating chamber 107. In this embodiment, the bottom 191 (partition wall 167), the top surface 193, and the rear-side inner wall surface 194 of the accommodating chamber 107 are formed by the first developing frame 151. Further, in this embodiment, the front-side inner wall surface 192 of the accommodating chamber 107 and a bottom 195 of the developing chamber 106 are formed by the second developing frame 152. However, the developing frame 150 is not limited to the constitution of this embodiment, but for example, the developing frame 150 may be constituted by connecting three or more frames to each other, or portions constituted by respective frames in the developing frame 150 may be different from those in this embodiment.

The conveying member 161 includes a shaft portion 161a provided substantially parallel to the longitudinal direction of the developing unit 140 and two conveying sheets (stirring sheets) 161b and 161c which are flexible sheet-like members each constituting a conveying portion for conveying the toner. The shaft portion 161a is provided over a substantially whole region between the inner wall surfaces on opposite sides of the accommodating chamber 107 with respect to the longitudinal direction. Each of the conveying sheets 161b and 161c is a sheet-like member extending over a substantially whole region of the shaft portion 161a with respect to the longitudinal direction. In addition, each of the conveying sheets 161b and 161c is fixed to the shaft portion 161a at one end portion (fixing end portion) thereof with respect to a widthwise direction (rotation radius direction) substantially perpendicular to the longitudinal direction. Each of the conveying sheets 161b and 161c is fixed to the shaft portion 161a by an arbitrary fixing means such as bonding, welding, or fastening. The other end portion of each of the conveying sheets 161b and 161c is a free end portion. The two conveying sheets 161b and 161c are fixed to an outer surface of the shaft portion 161a on sides opposite from each other so as to extend in opposite directions each toward an outside of the shaft portion 161a with respect to the rotation radius direction. The conveying member 161 is rotationally driven in an arrow R5 direction (counterclockwise direction) in FIG. 5 about a rotational axis O substantially parallel to the longitudinal direction of the developing unit 140. The shaft portion 161a is rotated in the arrow R5 direction in FIG. 5, so that the conveying sheets 161b and 161c are rotated in the same direction with rotation of the shaft portion 161a. By this, the conveying member 161 conveys (stirs) the toner by the conveying sheets 161b and 161c. As the conveying sheets 161b and 161c, it is possible to use a polyester film, a polyphenylene sulfide film, a polycarbonate film, or the like each having an appropriate thickness (for example, 300 μm).

The remaining amount detecting member (electroconductive sheet) 170 is provided on the front-side inner wall surface 192 in the accommodating chamber 107. Incidentally, details of a remaining amount detecting constitution for detecting a remaining amount of the developer in the developing unit 140 will be described later.

As shown in FIG. 7, the developing roller 103 and the supplying roller 104 are rotatably supported by a driving-side development bearing 153 and a non-driving-side development bearing 154 in opposite end portions with respect to each of longitudinal directions thereof. Each of the driving-side development bearing 153 and the non-driving-side development bearing 154 is fixed to the developing frame 150 (first developing frame 151, second developing frame 152) by an arbitrary fixing means such as bonding, welding, or fastening. Further, in this embodiment, the developing blade 156 is fixed to the developing frame 150 by that the supporting portion 156b is fixed on the developing frame 150 (first developing frame 151) by fixing screws 156c in two positions on one end portion side and the other end portion side with respect to the longitudinal direction. However, the developing blade 156 can be fixed to the developing frame 150 by an arbitrary fixing means such as bonding, welding, or fastening. Further, in this embodiment, the sealing sheet 105 is mounted to the developing frame 150 (second developing frame 152) by a double-side tape as a sticking means. However, the sealing sheet 105 can be fixed to the developing frame 150 by an arbitrary fixing means such as bonding, welding, or fastening. Further, the conveying member 161 (shaft portion 161a) is rotatably supported by the driving-side development bearing 153 and the non-driving-side development bearing 154 is opposite end portions with respect to the longitudinal direction.

As shown in FIG. 7, in a driving-side end portion of the developing unit 140 with respect to the longitudinal direction, a development drive input gear 159 as a drive transmitting member for transmitting a driving force of the developing unit 140 is provided. The development drive input gear 159 is provided with a development drive input coupling portion 159a as a drive input portion. The development drive input coupling portion 159a engages with a main assembly-side development drive coupling portion 40 (FIGS. 3 and 4) as a drive output portion provided in the apparatus main assembly 2. Further, a driving force from the driving motor (not shown) provided in the apparatus main assembly 2 is inputted into the developing unit 140 through the development drive input gear 159.

The driving force inputted to the developing unit 140 is transmitted from the development drive input gear 159 to a developing roller gear 157 as a drive transmitting member, so that the developing roller 103 is rotated. Further, the driving force inputted to the developing unit 140 is transmitted from the development drive input gear 159 to a supplying roller gear 158 as a drive transmitting member, so that the supplying roller 104 is rotated.

Further, the driving force inputted into the developing unit 140 is transmitted from the development drive input gear 159 to a conveying gear 160 as a drive transmitting member, so that the conveying member 161 is rotated. The developing roller gear 157, the supplying roller gear 158, and the conveying gear 160 are rotatably supported by the driving-side development bearing 153. Further, in a driving-side end portion of the developing unit 140 with respect to the longitudinal direction, a development cover member 155 for supporting the development drive input gear 159 and for covering the development drive input gear 159, the developing roller gear 157, the supplying roller gear 158, and the conveying gear 160, and the like is provided.

### Assembling of Drum Unit and Developing Unit

Next, assembling of the drum unit 120 and the developing unit 140 will be described.

As shown in FIG. 8, the drum unit 120 and the developing unit 140 are connected to each other by the driving-side cartridge cover member 122 and the non-driving-side cartridge cover member 123 provided in opposite end portions of the process cartridge 100 with respect to the longitudinal direction. The driving-side cartridge cover member 122 provided in the driving-side end portion of the process cartridge 100 with respect to the longitudinal direction is provided with a developing unit supporting hole 122b for swingably (movably) supporting the developing unit 140. Similarly, the non-driving-side cartridge cover member 123 provided with a developing unit supporting hole 123b for swingably supporting the developing unit 140. Further, the driving-side cartridge cover member 122 and the non-driving-side cartridge cover member 123 are provided with drum supporting holes 122a and 123a, respectively, for rotatably supporting the photosensitive drum 101.

In the driving-side end portion of the process cartridge 100 with respect to the longitudinal direction, in the developing unit supporting hole 122b of the driving-side cartridge cover member 122, an outer diameter portion of a cylindrical portion 155a of the development cover member 155 is engaged. Further, in the non-driving-side end portion of the process cartridge 100 with respect to the longitudinal direction, in the developing unit supporting hole 123b of the non-driving-side cartridge cover member 123, an outer diameter portion of a cylindrical portion (not shown) of the non-driving-side development bearing 154 is engaged. Further, opposite end portions of the photosensitive drum 101 with respect to the longitudinal direction are engaged in the drum supporting hole 122a of the driving-side cartridge cover member 122 and the drum supporting hole 123a of the non-driving-side cartridge cover member 123. Then, the driving-side cartridge cover member 122 and the non-driving-side cartridge cover member 123 are fixed to the drum unit 120 (drum frame 121) by an arbitrary fixing means such as screws, an adhesive, or the like. By this, the developing unit 140 is rotatably (swingably) supported relative to the drum unit 120 (photosensitive drum 101) by the driving-side cartridge cover member 122 and the non-driving-side cartridge cover member 123. For that reason, during the image formation, the developing roller 103 can be positioned in a position (contact position in this embodiment) where the developing roller 103 acts on the photosensitive drum 101.

As shown in FIG. 9, in the above-described manner, the drum unit 120 and the developing unit 140 are assembled, so that the process cartridge 100 is integrally formed.

Incidentally, an axis connecting a center of the developing unit supporting hole 122b of the driving-side cartridge cover member 122 and a center of the developing unit supporting hole 123b of the non-driving-side cartridge cover member 123 is also referred to as a swing axis A2. Here, the cylindrical portion 155a of the development cover member 155 is coaxial with the development input coupling 159a. That is, the developing unit 140 is constituted so that the driving force is transmitted on the above-described swing axis A2. With the above-described swing axis A2 as a center, the developing unit 140 is rotatably supported relative to the drum unit 120.

### Remaining Amount Detecting Constitution in Developing Unit

Next, a remaining amount detecting constitution for detecting a remaining amount of the developer in the developing unit 140 in this embodiment.

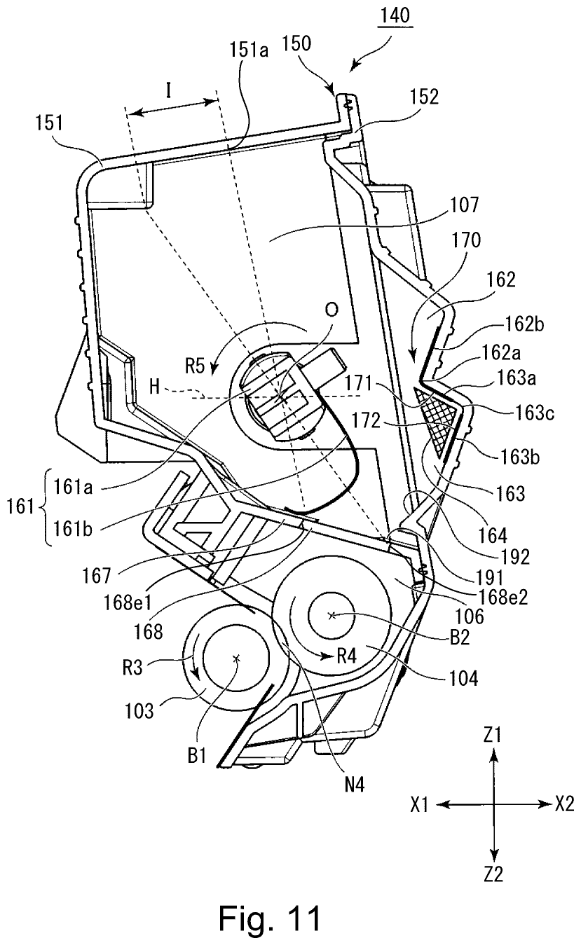

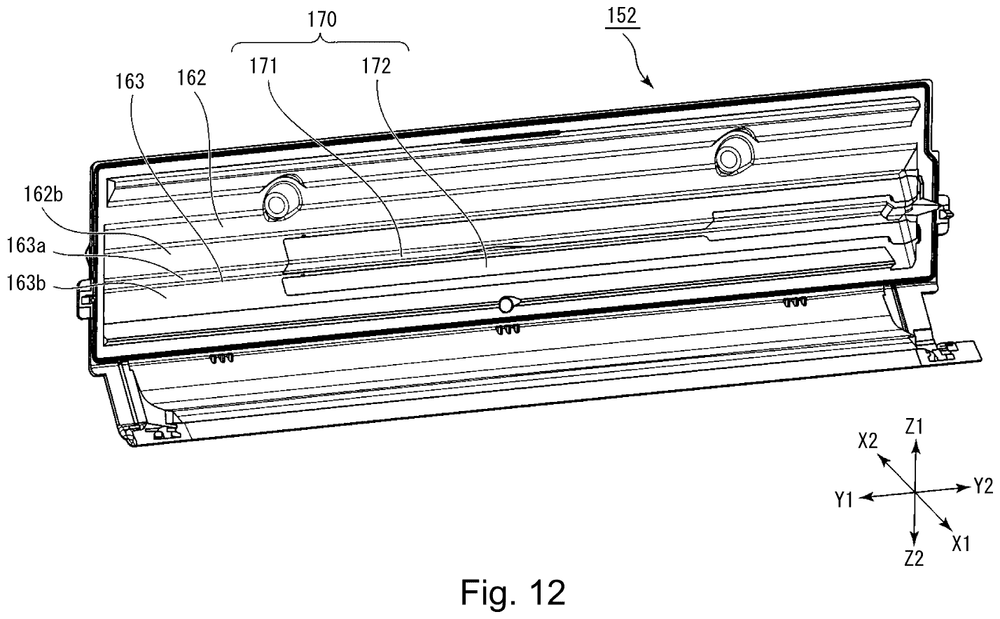

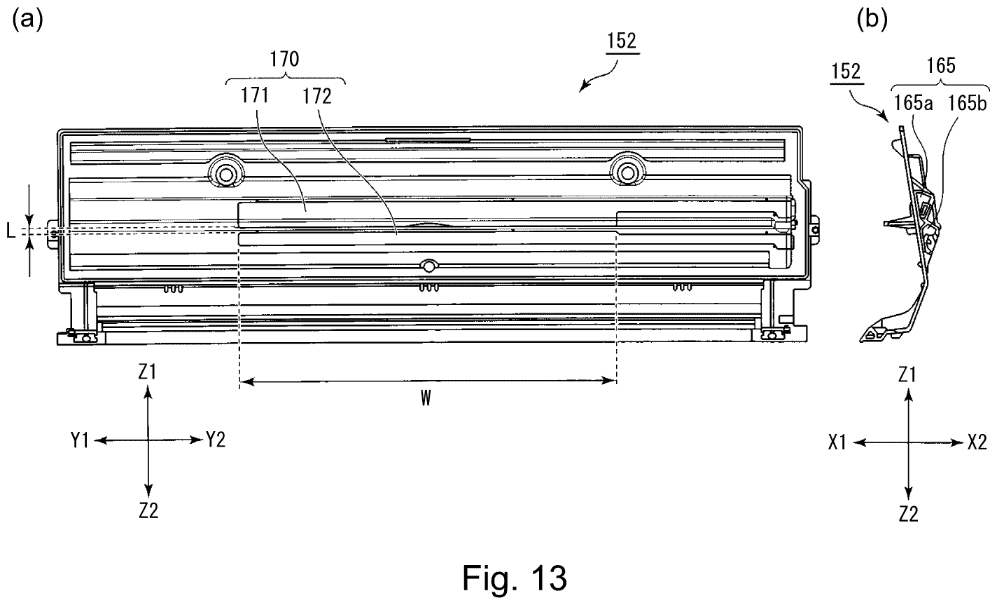

FIG. 10 is a schematic perspective view of the developing unit 140 (showing a state in which the developing unit 140 is viewed from somewhat at above along the X2 direction so that the left side in FIG. 10 is the driving side and the right side is the non-driving side). FIG. 11 is a schematic sectional view (Q-Q cross sectional view in FIG. 10) of the developing unit 140 in a substantially central portion with respect to the longitudinal direction, showing a state in which a cross section (XA plane) of the developing unit 140 substantially perpendicular to the Y direction is viewed from the non-driving side. FIG. 12 is a perspective view of the second developing frame 152 (showing a state in which the second developing frame 152 is viewed from somewhat above along the X2 direction so that the left side is the driving side and the right side is the non-driving side). Part (a) of FIG. 13 is a schematic front view of the second developing frame 152 along the X2 direction, i.e., viewed from a developing roller 103 side, and part (b) of FIG. 13 is a schematic side view of the second developing frame 152 as viewed from the non-driving side along the Y direction. In FIGS. 10 to 13, although the developing unit 140 is the developing unit 140 according to this embodiment similarly as shown in FIG. 5 and the like, but for simplicity, the developing unit 140 (or elements thereof) having a constitution in which a conveying member is provided with only a single conveying sheet 161b is shown. The same applies to FIGS. 15 to 17 described later.

On the front-side inner wall surface 192 of the second developing frame 152 (accommodating chamber 107), a recessed portion 163 extending (substantially parallel to) along the longitudinal direction of the second developing frame 152 is formed. The recessed portion 163 includes an upper surface (first surface) 163a of the inner wall surface of the accommodating chamber 107 and a lower surface (second surface) 163b of the inner wall surface of the accommodating chamber 107 which is positioned on a side downstream of the supply opening 168 and upstream of the upper surface 163a with respect to the longitudinal direction of the conveying member 161. In the cross section (XZ plane) substantially perpendicular to the longitudinal direction of the second developing frame 152, the upper surface 163a is constituted by a plane inclined so that a distance thereof from the rotational axis O of the conveying member 161 becomes shorter toward a downstream side of the rotational direction of the conveying member 161. Further, in the cross section (X2 plane) substantially perpendicular to the longitudinal direction of the second developing frame 152, the lower surface 163b is constituted by a plane inclined so that a distance thereof from the rotational axis O of the conveying member 161 becomes longer toward the downstream side of the rotational direction of the conveying member 161.

The upper surface 163a and the lower surface 163b are continuous at a bottom 163c of the recessed portion 163. An electroconductive sheet 170 which is an electroconductive sheet-like member constituting a remaining amount detecting member is provided on the upper surface 163a and the lower surface 163b which are two surfaces forming the recessed portion 163.

In this embodiment, inside the second developing frame 152, as the electroconductive sheet 170, a first electroconductive sheet 171 and a second electroconductive sheet 172 are provided. The first electroconductive sheet 171 is disposed on the upper surface 163a of the recessed portion 163, and the second electroconductive sheet 172 is disposed on the lower surface 163b of the recessed portion 163. The first electroconductive sheet 171 and the second electroconductive sheet 172 are disposed with a recessed portion interval L therebetween without contacting each other. On the front-side inner wall surface 192 of the second developing frame 152 (accommodating chamber 107), another recessed portion 162 extending along (substantially parallel to) the longitudinal direction of the second developing frame 152 is formed above and adjacently to the recessed portion 163. This another recessed portion 162 includes an apex portion 162a continuous to the upper surface 163a of the recessed portion 163 and an inclined surface 162b continuous to the apex portion 162a. In the cross section (XZ plane) substantially perpendicular to the longitudinal direction of the second developing frame 152, the inclined surface 162b is constituted by a flat surface inclined so that a distance from the rotational axis O of the conveying member 161 becomes long toward the downstream side of the rotational direction of the conveying member 161. The first electroconductive sheet 171 is disposed so as to be continuous over two surfaces consisting of the upper surface 163a of the recessed portion 163 and the inclined surface 162b of the above-described another recessed portion 162.

The first electroconductive sheet 171 is provided so that a portion thereof disposed on the inclined surface 162b of the another recessed portion 162 is continuous to the non-driving-side end portion of the second developing frame 152 with respect to the longitudinal direction. Further, the second electroconductive sheet 172 is provided so as to be continuous on the lower surface 163b of the recessed portion 163 to the non-driving-side end portion of the second developing frame 152 with respect to the longitudinal direction. A portion of the first electroconductive sheet 171 disposed on the upper surface 163a of the recessed portion 163 and a portion of the second electroconductive sheet 172 disposed opposed to this portion (of the first electroconductive sheet 17) on the lower surface 163b of the recessed portion 163 are arranged adjacently to each other with the predetermined interval L. That is, a closest portion between the first electroconductive sheet 171 and the second electroconductive sheet 172 is limited to a predetermined range (detection range) W extending symmetrically from a center of the second developing frame 152 toward each of opposite end portion sides with respect to the longitudinal direction. A space (hatched portion in FIG. 11) sandwiched between the first electroconductive sheet 171 and the second electroconductive sheet 172 in the detection range W is a remaining amount detecting portion 164.

Incidentally, a shape of the recessed portion 163 in which the remaining amount detecting portion 164 is provided is not limited to the shape in this embodiment. For example, an appropriate shape such as a recessed portion constituted by a curved surface can be used. Further, in this embodiment, from a viewpoint of manufacturing or the like, the first electroconductive sheet 171 is provided over the two surfaces of the second developing frame 152, but may also be provided on only first surface similarly as in the case of the second electroconductive sheet 172.

Here, in this embodiment, the first and second electroconductive sheets 171 and 172 are formed with an electroconductive resin sheet. In this embodiment, a thickness of the first and second electroconductive sheets 171 and 172 is 0.1 mm. In this embodiment, as the first and second electroconductive sheets 171 and 172, a resin sheet of 1.15 kΩ/sq or less in surface resistivity was used. Further, in this embodiment, as a material of the first and second electroconductive sheets 171 and 172, a resin of an ethylene vinyl acetate copolymer (EVA) type in which carbon black was dispersed was used. Further, in this embodiment, the first and second electroconductive sheets 171 and 172 are integrally molded with the second developing frame 152 by insert molding and are mounted to the second developing frame 152. In this embodiment, from viewpoints of the influence of deformation of the frame, a transfer property to a frame shape, electroconductivity, and the like, as the first and second electroconductive sheets 171 and 172, the 0.1 mm-thick resin sheet was used, but the thickness of the resin sheet can be appropriately selected. Further, in this embodiment, as the material of the first and second electroconductive sheets 171 and 172, the resin of EVA type was used, but resins of polystyrene (PS) type, acrylonitrile butadiene styrene (ABS) type, polyphenylene oxide (PRO) type, and the like may be used. Further, in this embodiment, as the first and second electroconductive sheets 171 and 172, the resin sheet was used and was mounted to the developing frame 150 by the insert molding, but the present invention is not limited thereto. For example, as the first and second electroconductive sheets 171 and 172, a sheet made of metal or the like may be used and may be fixed (stuck) to the developing frame 150 by an arbitrary fixing means such as bonding, welding, or fastening.

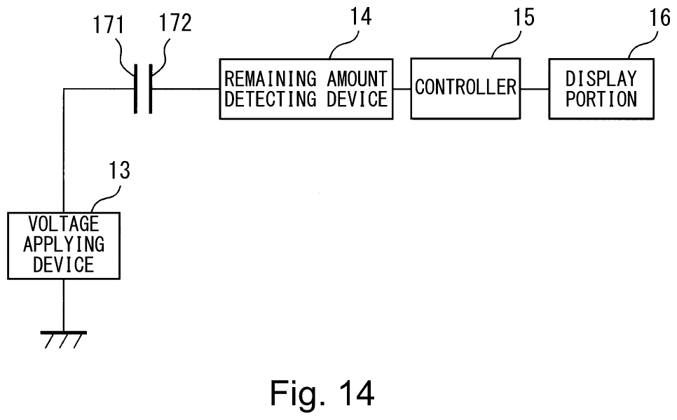

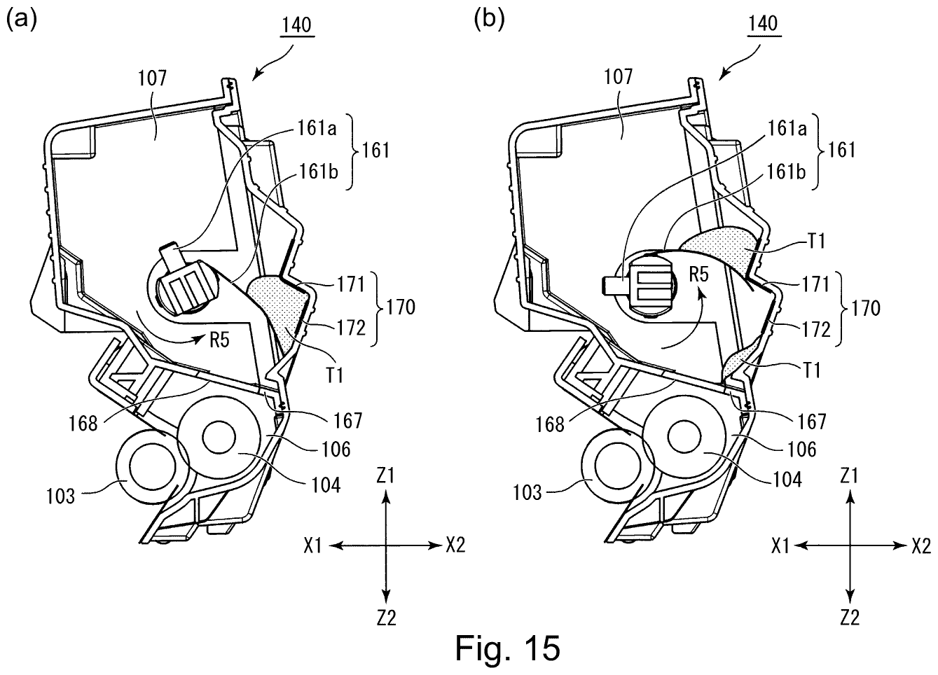

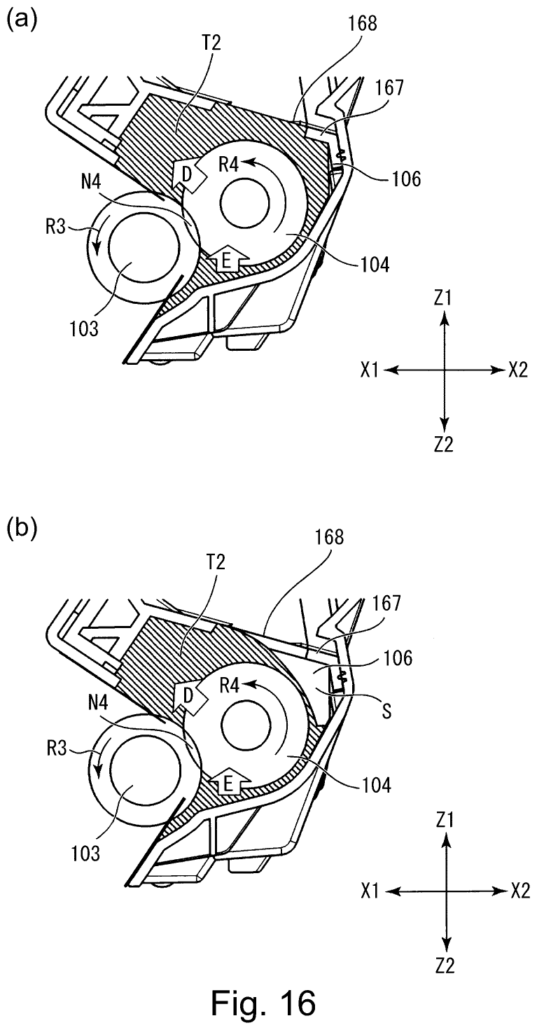

FIG. 14 is a schematic view showing a schematic circuit constitution for detecting the remaining amount of the developer in the developing unit 140 in this embodiment. A method for measuring electrostatic capacity of the remaining amount detecting portion 164 by the first and second electroconductive sheets 171 and 172 will be described. In the apparatus main assembly 2, a voltage applying device (power source) 13 capable of applying an AC voltage (alternating voltage) as a remaining amount detecting bias (remaining amount detecting voltage) to the first electroconductive sheet 171, and a remaining amount detecting device (detecting circuit) 14 electrically connected to the second electroconductive sheet 172 are provided. Electric conduction between the first and second electroconductive sheet 171 and 172 disposed inside the second developing frame 152, and the voltage applying device 13 and the remaining amount detecting device 14 disposed outside the second developing frame 152 may only be required to be established by an arbitrary method.

For example, a part of the second developing frame 152 is constituted by the electroconductive resin or the electroconductive member is incorporated into a part of the second developing frame 152, so that the members inside and outside the second developing frame 152 can be constituted so as to be electrically connected to each other.

In this embodiment, as shown in part (b) of FIG. 13, in the non-driving-side end portion of the second developing frame 152, a first electroconductive resin contact 165a and a second electroconductive resin contact 165b which are integrally formed with the second developing frame 152 by two-color molding are provided. The first electroconductive resin contact 165a and the second electroconductive resin contact 165b contact the first electroconductive sheet 171 and the second electroconductive sheet 172, respectively, so that the members inside and outside the developing unit 140 are electrically conducted to each other. Further, through the non-driving-side development bearing 154 (FIG. 7), the first electroconductive sheet 171 and the voltage applying device 13 provided in the apparatus main assembly 2 are connected to each other, and a voltage is applied to the first electroconductive sheet 171. Further, through the non-driving-side development bearing 154 (FIG. 7), the second electroconductive sheet 172 and the remaining amount detecting device 14 provided in the apparatus main assembly 2 are connected to each other, and a detection output depending on the remaining amount of the developer in the developing unit 140 is acquired. The first and second electroconductive sheets 171 and 172 perform a function as pole plates, and form a capacitor inside the developing unit 140. That is, the first electroconductive sheet 171 and the second electroconductive sheet 172 constitute a first electrode and a second electrode, respectively, as a detecting member. The first and second electroconductive sheets 171 and 172 are aligned (arranged) in a rotational direction of the conveying member 161, and each extends along a rotational axis direction of the conveying member 161.

When an AC voltage is applied to the first electroconductive sheet 171, a current corresponding to electrostatic capacity is induced in the remaining amount detecting portion 164 which is a space between the first electroconductive sheet 171 and the second electroconductive sheet 172, so that this current value is outputted as a signal. An angle formed between the first electroconductive sheet 171 and the second electroconductive sheet 172 in a portion forming the remaining amount detecting portion 164 may preferably be set to 95° or more and 110° or less, in which the electrostatic capacity can be stably measured. This electrostatic capacity changes depending on an amount of the developer occupied in the remaining amount detecting portion 164. A change in electrostatic capacity is inputted as a current value to the remaining amount detecting portion 164. Then, a controller (control circuit) 15 provided in the apparatus main assembly 2 is capable of sequentially calculating the remaining amount of the developer in the developing unit 140 on the basis of the current value inputted to the remaining amount detecting device 14. Further, the controller 15 is capable of carrying out control so as to notify information on the remaining amount of the developer in the developing unit 140 to a display portion 16 provided to the apparatus main assembly 2 or a display portion of an external device such as a personal computer or the like connected to the image forming apparatus 1. Incidentally, an electrostatic capacity detecting method is not limited to the above-described method. For example, a constitution in which the first electroconductive sheet 171 is electrically connected to the remaining amount detecting device 14 and the second electroconductive sheet 172 is electrically connected to the voltage applying device and in which the electrostatic capacity is detected by applying an AC voltage to the second electroconductive sheet 172 may be employed.

A relationship between an operation of the conveying member 161 and a detecting operation of the amount of the developer by the remaining amount detecting portion 164 will be further described. As described above, the recessed space sandwiched between the first electroconductive sheet 171 and the second electroconductive sheet 172 in the detection range W is the remaining amount detecting portion 164. Further, the amount of the developer conveyed into the remaining amount detecting portion 164 by the conveying member 161 is detected, so that the remaining amount of the developer in the developing unit 140, i.e., a “total developer remaining amount” which is the sum of the remaining amount of the developer in the developer accommodating chamber and the developer in the developing chamber is calculated.

Part (a) of FIG. 15 is a schematic sectional view (sectional view taken along Q-Q line in FIG. 10) of the developing unit 140 similar to FIG. 11 and shows a state at the moment when a developer (toner)-to-be-conveyed T1 is conveyed to the remaining amount detecting portion 164 by the conveying sheet 161b and is detected by the remaining amount detecting portion 164. In this embodiment, a length of the conveying sheet 161b with respect to the widthwise direction is set so that a free end of a free end portion of the conveying sheet 161b is movable in contact with at least a part of the bottom 191 and the front-side inner wall surface 192 of the accommodating chamber 107. At least the part of the front-side inner wall surface 192 typically includes at least a part of the lower surface 163b of the recessed portion 163. That is, in the cross section (XZ plane) substantially perpendicular to the longitudinal direction of the developing unit 140, the length of the conveying sheet 161b with respect to the widthwise direction is longer than a distance from the rotational axis (rotation center) O of the conveying member 161 to at least the part of the bottom 191 and the front-side inner wall surface 192. For that reason, even in the case where the amount of the developer in the accommodating chamber 107 is relatively small as shown in part (a) of FIG. 15, the conveying sheet 161b raises the developer and conveys the developer to the remaining amount detecting portion 164. Thus, the conveying member 161 is constituted so that an outside free end thereof with respect to the rotation radius direction is moved in contact with at least a part of the partition wall 167. Further, in the case where the developing unit 140 takes an attitude when the developing unit 140 is used for image formation in the image forming apparatus 1, the remaining amount detecting portion 164 is provided on the inner wall surface of the accommodating chamber 107 in a position where a free end of the conveying member 161 is moved upward while contacting the inner wall surface immediately after being separated from the partition wall 167. That is, in the case where the developing unit 140 takes the attitude when the developing unit 140 is used for the image formation in the image forming apparatus 1, at least a part of the remaining amount detecting portion 164 is disposed in a position where the developer raised and conveyed by the conveying member 161 is supplied. In other words, at least the part of the remaining amount detecting portion 164 is provided in a region of the inner wall surface to which the free end portion of the conveying member 161 is contacted when the free end portion of the conveying member 161 is separated from the partition wall 167 and then is rotated upward. Incidentally, in this embodiment, the conveying sheet 161b conveys the developer while being flexed in an opposite direction to the rotational direction of the conveying member 161. At this time, the developer (toner) is a dielectric material, so that the electrostatic capacity between the first and second electroconductive sheets 171 and 172 performing the function of the pole plates of the capacitor increases.

On the other hand, part (b) of FIG. 15 is a schematic sectional view (sectional view taken along the Q-Q line in FIG. 10) of the developing unit 140 similar to FIG. 11 and shows a state immediately after the conveying sheet 161b passes through the recording material detecting portion 164. A part of the developer-to-be-conveyed T1 is raised upward than the remaining amount detecting portion 164 by the conveying sheet 161b, and a part of the developer-to-be-conveyed T1 drops from the remaining amount detecting portion 164 by its own weight, so that a distribution as shown in part (b) of FIG. 15 is obtained. Thus, the developer which is the dielectric material runs out (or decreases) in the remaining amount detecting portion 164, so that the electrostatic capacity between the first and second electroconductive sheets 171 and 172.

Incidentally, as described above, for simplicity, only one conveying sheet 161b is shown in FIG. 15, but in this embodiment, behavior of the developer by each of the two conveying sheets 161b and 161c is substantially the same.

With consumption of the developer by the image formation, the amount of the developer conveyed by the conveying member 161 gradually decreases. For that reason, a “time when the developer exists in the remaining amount detecting portion 164”, i.e., a “time when the electrostatic capacity increases” similarly decreases. In this embodiment, the remaining amount detecting device 14 is constituted so as to be capable of detecting the remaining amount of the developer in the developing unit 140 by measuring this decreasing “time when the electrostatic capacity increases”.

Here, in order to improve detection accuracy of the remaining amount of the developer in the developing unit 140, the developing unit 140 is required to have a constitution such that the calculation result of the above-described total developer remaining amount is more stabilized.

### Improvement in Detection Accuracy of Remaining Amount of Developer

Next, using FIGS. 11, 16, and 17, a constitution for improving the detection accuracy of the remaining amount of the developer in the developing unit 140 will be described.

As features of the developing unit 140, it is possible to cite the following three features (first to third features).

As the first feature, with respect to the rotational direction (arrow R5 direction in FIG. 11) of the conveying member 161, the remaining amount detecting portion 164 is disposed on a side downstream of the supply opening 168. That is, the remaining amount detecting portion 164 is disposed on the side downstream of the supply opening 168 with respect to a movement direction of the conveying sheet 161b (represented by the free end of the free end portion with respect to the widthwise direction), i.e., with respect to a conveying direction of the developer by the conveying member 161. However, with respect to the rotational direction (arrow R5 direction in FIG. 11) of the conveying member 161, the remaining amount detecting portion 164 is disposed on a side upstream of a region I which is a region of the inner wall surface of the accommodating chamber 107 and which is positioned on a side opposite from the supply opening 168 relative to the rotational axis O of the conveying member 161.

In other words, the remaining amount detecting portion 164 is, as shown in FIG. 11, in a region of the inner wall surface between a first point 168e2 and a second point 151a with respect to the rotational direction (arrow R5 direction in FIG. 11) of the conveying member 161, in which the first point 168e2 is a downstream end of the supply opening 168 with respect to the rotational direction (arrow R5 direction in FIG. 11), and the second point 151a is a point at which a virtual line passing through an upstream end 168e1 of the supply opening 168 with respect to the rotational direction (arrow R5 direction in FIG. 11) and the rotational axis O intersects (crosses) the inner wall surface.

From a viewpoint such as a conveying property of the developer to the remaining amount detecting portion 164 by the conveying sheet 161b, the remaining amount detecting portion 164 may preferably be disposed in a position of a height which is not more than a height of a horizontal line H passing through the rotational axis O of the conveying member 161. That is, it is preferable that at least a part of the remaining amount detecting portion 164 is positioned at the height which is not more than the height of the horizontal line H passing through the rotational axis O of the conveying member 161 in a gravitational direction.

As the second feature, the rotational direction (arrow R5 direction in FIG. 11) of the conveying member 161 and a rotational direction (arrow R4 direction in FIG. 11) of the supplying roller 104 are the same direction.

As the third feature, in the gravitational direction (arrow Z2 direction in FIG. 11), a rotational axis B2 of the supplying roller 104 is disposed in a position of a height which is not less than a height of a rotational axis B1 of the developing roller 103. However, typically, on a side opposite from the photosensitive drum 101 relative to a vertical line passing through the rotational axis B1 of the developing roller 103, the rotational axis B2 of the supplying roller 104 is disposed. In other words, the rotational axis B2 of the supplying roller 104 is positioned closer to the supply opening 168 than the rotational axis B1 of the developing roller 103 is.

Incidentally, the above-described positional relationship (operation relationship) may only be required to be satisfied in the case where the developing unit 140 takes the attitude when the developing unit 140 is used for the image formation in the image forming apparatus 1. Further, the above-described positional relationship (operation relationship) is that in the case where the developing unit 140 is viewed in a cross section substantially perpendicular to the longitudinal direction thereof.

Here, a phenomenon having the influence on detection accuracy of the remaining amount of the developer in the developing unit 140 will be described.

Part (a) of FIG. 16 is a schematic sectional view of the neighborhood of the supplying roller 104 in a state in which a developer (toner)-to-be-filled T2 is filled in the developing chamber 106 (showing a state in which the cross section (XZ plane) substantially perpendicular to the Y direction is viewed from the non-driving side). The supplying roller 104 includes a sleeve (foamed elastic member layer) formed with a sponge (foamed elastic member) and holds the developer therein. In the developing chamber 106, the developing roller 103 and the supplying roller 104 contact each other along the longitudinal direction, and the sponge of the supplying roller 104 is compressed partially by the developing roller 103 higher in hardness, so that a supplying portion (region-to-be-compressed, supply nip) N4 is formed. Then, in the neighborhood of the supplying portion N4 on an upstream side with respect to the rotational direction R4 of the supplying roller 104, a state of the supplying roller 104 is shifted from a state in which the sponge is not compressed to a state in which the sponge is compressed. For that reason, the developer inside the sponge is discharged from the sponge as shown by an arrow D in part (a) of FIG. 16. On the other hand, in the neighborhood of the supplying portion N4 on a downstream side, the state of the supplying roller 104 is restored from the state in which the sponge is compressed to the state in which the sponge is not compressed. For that reason, the developer at a periphery of the sponge is absorbed by the sponge as shown by an arrow E in part (a) of FIG. 16.

Part (b) of FIG. 16 is a schematic sectional view of the neighborhood of the supplying roller 104 for illustrating behavior of the developer in the developing chamber 106 with discharge and absorption of the developer by the above-described supplying roller 104 (showing a state in which the cross section (XZ plane) substantially perpendicular to the Y direction is viewed from the non-driving side). On a side downstream of the supplying portion N4 with respect to the rotational direction R4 of the supplying roller 104, the developer is decreased by the above-described absorption (arrow E) of the developer, and therefore, the developer-to-be-filled T2 in the developing chamber 106 shows a distribution as illustrated in part (b) of FIG. 16, so that a gap S is generated in the developing chamber 106. A volume of this gap S is fluctuated by a consumption amount of the developer depending on an image to be formed and by the state of the supplying roller 104, or the like, so that it is hard to estimate the volume of the gap S.

As described above, in the remaining amount detecting portion 164, the amount of the developer conveyed by the conveying member 161 in the accommodating chamber 107 is detected. Further, the total developer remaining amount which is the sum of the amount of the developer in the accommodating chamber 107 and the amount of the developer in the developing chamber 106 is calculated. That is, the amount of the developer detected by the remaining amount detecting portion 164 is just the “amount of the developer conveyed in the accommodating chamber 107”, and does not include a parameter corresponding to the amount of the developer in the developing chamber 106. However, as described above, in the case where the gap S in which the volume thereof fluctuates is formed, the amount of the developer in the developing chamber 106 varies, and therefore, a difference between the calculated total developer remaining amount and an actual remaining amount of the developer in the developing chamber 106 is generated, so that there is a possibility that the detection accuracy of the remaining amount of the developer lowers.

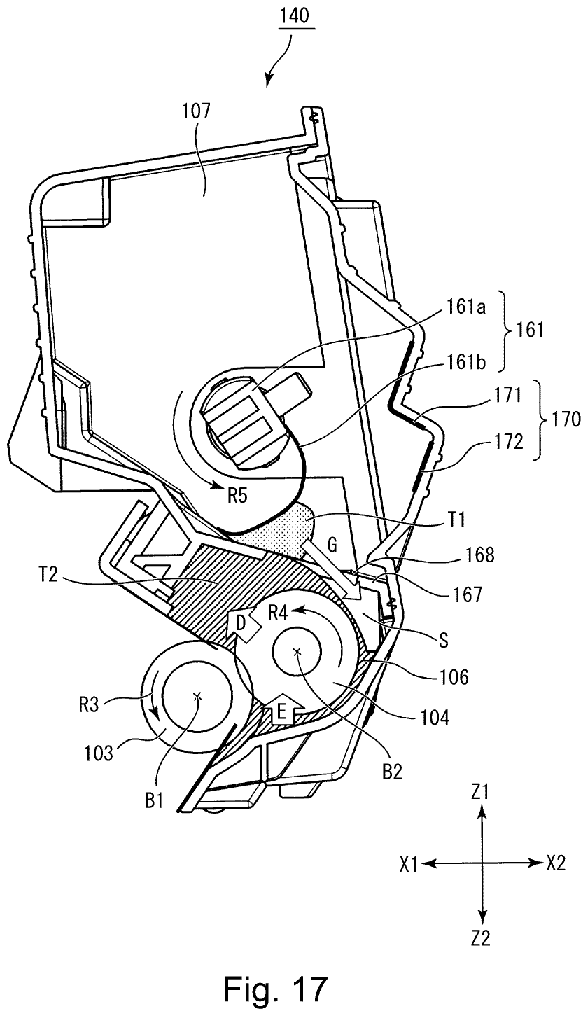

Next, an effect by the constitution of this embodiment will be described. FIG. 17 is a schematic sectional view of the developing unit 140, similar to the developing unit 140 in FIG. 11, for illustrating the effect by the constitution of this embodiment.

By the first feature described above, the conveying sheet 161b passes through the supply opening 168 before the conveying sheet 161b conveys the developer-to-be-conveyed T1 to the remaining amount detecting portion 164. For that reason, the amount of the developer detected in the remaining amount detecting portion 164 becomes an “amount of the developer conveyed by the conveying member 161 depending on the amount of the developer in the accommodating chamber 107 after the developer is filled in the gap S in the developing chamber 106”. That is, in the case of the positional relationship as cited by the above-described first feature, a state in which the developer is filled in the gap S in the developing chamber 106 when the amount of the developer is detected in the remaining amount detecting portion 164 is easily formed. For that reason, the gap S which can cause a variation in detection result of the amount of the developer in the remaining amount detecting portion 164 is reduced, so that the amount of the developer in the developing chamber 106 is easily stabilized. Accordingly, a calculation result of the total developer remaining amount which is the sum of the amount of the developer in the accommodating chamber 107 and the amount of the developer in the developing chamber 106 is stabilized, so that the detection accuracy of the developer in the developing unit 140 is improved.

Here, in order to further improve the effect by the above-described first feature, it is desired that with respect to the conveying direction (direction along the rotational direction R5) of the developer by the conveying member 161, the gap S exists on a side downstream of the supply opening 168. By this, as shown by an arrow G in FIG. 17, the developer conveyed by the conveying member 161 is more smoothly filled in the gap S. For this purpose, by the above-described second feature, a position where the discharge (arrow D) and the absorption (arrow E) of the developer by the supplying roller 104 occur provides the positional relationship as shown in FIG. 17. That is, the developer is easily discharged from the supplying roller 104 toward an upstream side of the supply opening 168 with respect to the conveying direction of the developer by the conveying member 161. Further, the developer positioned on a downstream side of the supply opening 168 with respect to the conveying direction of the developer by the conveying member 161 is easily absorbed by the supplying roller 104. By this, the gap S is easily generated on a side downstream of the supply opening 168 with respect to the conveying direction of the developer by the conveying member 161.

Further, in order to further reliably obtain the effect by the above-described second feature, the developing unit 140 may preferably have the above-described third feature. By the above-described third feature, the positional relationship between the positions where the discharge (arrow D) and the absorption (arrow E) of the developer by the supplying roller 104 occur is not reversed. That is, it is prevented that the developer is easily discharged form the supplying roller 104 toward the downstream side of the supply opening 168 and that the developer positioned on the upstream side of the supply opening 168 is easily absorbed. For that reason, a status such that the gap S is easily generated on the downstream side of the supply opening 168 with respect to the conveying direction of the developer by the conveying member 161 can be formed.

In this embodiment, the developing unit 140 has the above-described first to third features, but a corresponding effect similar to the above-described effect can be obtained when the first feature is provided. Further, for example, in the case of the constitution in which the supplying roller 104 includes the foamed elastic member layer constituting the surface layer, the above-described second and third features are provided, so that the effect of improving the detection accuracy of the remaining amount of the developer in the developing unit 140 can be more enhanced.

As described above, according to this embodiment, in a state in which the gap in the developing chamber 106 causing a fluctuation in amount of the developer detected by the remaining amount detecting portion 164 is filled with the developer, detection of the amount of the developer in the remaining amount detecting portion 164 can be executed. By this, a value of the total developer remaining amount which is the calculated sum of the amount of the developer in the accommodating chamber 107 and the amount of the developer in the developing chamber 106 is stabilized. Accordingly, the detection accuracy of the remaining amount of the developer in the developing unit 140 is improved.

### Other Embodiments

In the above, the present invention was described based on a specific embodiment, but the present invention is not limited to the above-described embodiment.

In the above-described embodiment, the image forming apparatus was of the process cartridge type, but the present invention is not limited thereto. The developing device may be fixed to the apparatus main assembly of the image forming apparatus. Further, the developing device may be made detachably mountable to the apparatus main assembly of the image forming apparatus substantially singly. Further, the image forming apparatus may have a constitution in which the developer is capable of being supplied from the supply container to the developing device fixed to or detachably mountable to the apparatus main assembly. In this case, the supply container may be mounted to the developing device during the supply of the developer and then may be demounted from the developing device before the image formation is carried out, or the image formation may be carried out while the supply container is mounted to the developing device as it is.

Further, in the above-described embodiment, as the developer remaining amount detecting type, the electrostatic capacity type was used, but the present invention is not limited thereto. As the developer remaining amount detecting type, for example, an arbitrary utilizable type such as a light transmission type can be used. The light transmission type is a type in which a light source for irradiating a detecting portion in the accommodating chamber with light and a light receiving portion for receiving the light passed through an inside of the developing device are used and in which the amount of the developer is detected on the basis of a change in light receiving state (presence/absence of the received light, light receiving amount, light receiving time) of the light receiving portion.

Further, in the above-described embodiment, the supplying roller was rotationally driven in the direction such that the surface movement direction of the developing roller and the surface movement direction of the supplying roller are opposite directions in the opposite portion (contact portion) with the developing roller, but the present invention is not limited thereto. The supplying roller may be rotationally driven in a direction such that the surface movement direction of the developing roller and the surface movement direction of the supplying roller are the same (forward) direction in the opposite portion (contact portion) with the developing roller. Also, in this case, in accordance with the above-described embodiment, the above-described features are provided, so that an effect similar to the effect in the above-described embodiment can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057831 filed on Mar. 29, 2024, which is hereby incorporated by reference herein in its entirety.

What is claimed is:

1. A developing device used for image formation in an image forming apparatus, comprising:
a developing roller configured to carry a developer;
a supplying roller configured to supply the developer to the developing roller in contact with the developing roller; and
a developing container by which the developing roller is rotatably supported, the developing container including
a developing chamber provided with the supplying roller,
a developer accommodating chamber partitioned from the developing chamber by a partition wall provided with an opening and configured to accommodate the developer, the developer accommodating chamber communicating with the developing chamber through the opening and being positioned above the developing chamber when the developing device takes an attitude in which the developing device is used for the image formation,
a conveying member provided in the developer accommodating chamber and configured to convey the developer from the developer accommodating chamber toward the developing chamber through the opening, the conveying member being rotatable about a rotational axis thereof in a rotational direction opposite to a rotational direction of the supplying roller, and
a detecting portion configured to output a signal depending on an amount of the developer accommodated in the developing chamber, the detecting portion being provided on an inner wall surface constituting the developer accommodating chamber,
wherein in a cross section perpendicular to the rotational axis, the detecting portion is provided in a region of the inner wall surface positioned between a first point and a second point with respect to the rotational direction of the conveying member, the first point being a downstream end of the opening with respect to the rotational direction, and the second point being a point where a virtual line passing through the rotational axis and an upstream end of the opening with respect to the rotational direction crosses the inner wall surface.

2. The developing device according to claim 1, wherein in a case where the developing device takes the attitude, a rotational axis of the supplying roller is positioned at a height not less than a height of a rotational axis of the developing roller in a gravitational direction.

3. The developing device according to claim 1, wherein the supplying roller includes a foamed elastic layer constituting a surface layer, and the foamed elastic layer is compressed by the developing roller in a contact portion between the supplying roller and the developing roller.

4. The developing device according to claim 1, wherein in a case where the developing device takes the attitude, at least a part of the detecting portion is disposed in a position to which the developer raised and conveyed by the conveying member is supplied.

5. The developing device according to claim 4, wherein in a case where the developing device takes the attitude, at least a part of the detecting portion is positioned at a height not less than a height of a horizontal line passing through the rotational axis of the conveying member in a gravitational direction.

6. The developing device according to claim 1, wherein the conveying member is constituted so as to move while contacting at least a part of the partition wall at an outer free end portion thereof in a rotation radius direction of the conveying member, and
wherein in a case where the developing device takes the attitude, the detecting portion is provided in the region of the inner wall surface to which the free end portion of the conveying member is contacted when being rotated toward above after being separated from the partition wall.

7. The developing device according to claim 6, wherein in the case where the developing device takes the attitude, at least a part of the detecting portion is positioned at a height not less than a height of a horizontal line passing through the rotational axis of the conveying member in a gravitational direction.

8. The developing device according to claim 1, wherein the detecting portion is provided in a recessed portion recessed toward an outside of the inner wall surface of the developer accommodating chamber.

9. The detecting portion according to claim 8, wherein the detecting portion includes a first electrode and a second electrode provided on a first surface and a second surface, respectively, which constitute the recessed portion and which oppose each other, and the detecting portion sends a signal depending on electrostatic capacity between the first electrode and the second electrode, and
wherein the developer is supplied to between the first electrode and the second electrode by rotation of the conveying member.

10. The developing device according to claim 9, wherein the first electrode and the second electrode are arranged in the rotational direction of the conveying member, and each of the first electrode and the second electrode is extended along a direction of the rotational axis of the conveying member.

11. The developing device according to claim 10, wherein in the cross section, the first surface is inclined so that a distance from the rotational axis of the conveying member becomes short toward a downstream side of the rotational direction of the conveying member, and
wherein in the cross section, the second surface is provided in a region of the inner wall surface between the first point and the first surface with respect to the rotational direction of the conveying member, and the second surface is inclined so that a distance from the rotational axis of the conveying member becomes long toward the downstream side of the conveying member.
